(19) United States
(12) Patent Application Publication
(10) Pub. No.: US 2017/0084248 A1
(43) Pub. Date: Mar. 23, 2017

(54) SYSTEMS AND METHODS FOR IMPROVING ANGULAR DISTRIBUTION OF LIGHT AND TOTAL LIGHT THROUGHPUT IN A DISPLAY DEVICE

(71) Applicant: Pixtronix, Inc., San Diego, CA (US)

(72) Inventors: Jianru Shi, San Jose, CA (US); Lu Lu, Woburn, MA (US); Ji Ma, Acton, MA (US); Xiang-Dong Mi, Acton, MA (US); Jignesh Gandhi, Acton, MA (US); Teruo Sasagawa, Los Gatos, CA (US); Matthew Brian Sampsell, San Jose, CA (US)

(21) Appl. No.: 14/861,660

(22) Filed: Sep. 22, 2015

(51) Int. Cl. G09G 5/00; G02B 26/04; G09G 5/10

(52) U.S. Cl. CPC G09G 5/006; G09G 5/10; G02B 26/04; G09G 2320/0626; G09G 2310/027; G09G 2320/068

(57) ABSTRACT

This disclosure provides systems, methods, and apparatus for improving angular distribution of light and total light throughput in a display device. A display device can include first and second substrates and an array of display elements positioned between the first and second substrates. A first light blocking layer can be positioned on the first substrate and can define a first plurality of apertures. A second light blocking layer can be positioned on the second substrate and can define a first second of apertures. A plurality of reflective sidewalls can be positioned adjacent to at least one edge of a respective aperture of the first plurality of apertures. The reflective sidewalls can help to improve angular distribution of light and total light throughput of the display device.

### TECHNICAL FIELD

This disclosure relates to the field of imaging displays, and to structures that can be incorporated into displays to improve angular distribution of light and total light throughput.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, or a combination of these or other micromachining processes that etch away parts of substrates, the deposited material layers, or both. Such processes may also be used to add layers to form electrical and electromechanical devices.

EMS-based display apparatus can form images by modulating light as it travels an optical path between opposing apertures in light blocking layers. Narrow dimensions of apertures in the light blocking layers can reduce the range of angles of light that are permitted to pass through such apertures, as well as reduce the total light throughput of the display.

### SUMMARY

The systems, methods and devices of this disclosure each have several innovative aspects, no single one of which is solely responsible for the desirable attributes disclosed herein.

One innovative aspect of the subject matter described in this disclosure can be implemented in a display apparatus. The display apparatus can include a first substrate, a second substrate substantially parallel to the first substrate, and an array of light modulators positioned between the first substrate and the second substrate. The display apparatus can include a first light blocking layer positioned on the first substrate and defining a first plurality of apertures. The display apparatus can include a second light blocking layer positioned on the second substrate and defining a second plurality of apertures. Each of the second plurality of apertures can be aligned with a respective aperture in the first plurality of apertures. The display apparatus can include a first plurality of reflective sidewalls each adjacent to at least one edge of a respective aperture of the first plurality of apertures and between the first and second substrates.

In some implementations, each of the first plurality of sidewalls is oriented at an angle between about 45 degrees and about 90 degrees with respect to a surface of the first substrate. In some implementations, each of the first plurality of apertures has a length to width ratio in the range of about 4:1 to about 6:1. In some implementations, the first plurality of sidewalls includes sidewalls positioned adjacent to a longer edge of each aperture of the first plurality of apertures. In some implementations, each sidewall surrounds its respective aperture.

In some implementations, the display apparatus can include a plurality of structural projections positioned over the first light blocking layer. Each sidewall of the first plurality of reflective sidewalls can be positioned on a surface of a respective structural projection. In some implementations, each structural projection has a height in the range of about 1.5 microns to about 5 microns. In some implementations, the structural projections include a light blocking material.

In some implementations, the display apparatus can include a light blocking material positioned on a surface of each of the structural projections farthest from the first substrate. In some implementations, each reflective sidewall includes at least one of aluminum, titanium, and silver. In some implementations, each reflective sidewall includes at least one of a dielectric mirror and a dielectrically enhanced mirror.

In some implementations, the display apparatus can include an aperture layer positioned between the first light blocking layer and the second light blocking layer. The aperture layer can define a third plurality of apertures each aligned with a respective aperture in the first plurality of apertures. In some implementations, the aperture layer includes the reflective sidewalls. In some implementations, each light modulator is coupled to and suspended over one of the first substrate and the second substrate. In some implementations, the display apparatus can include a second plurality of reflective sidewalls each positioned adjacent to at least one edge of a respective aperture of the second plurality of apertures.

In some implementations, the display apparatus can include a processor capable of communicating with the display apparatus. The processor can be capable of processing image data. The display apparatus also can include a memory device capable of communicating with the processor. In some implementations, the display apparatus can include a driver circuit capable of sending at least one signal to the display apparatus and a controller capable of sending at least a portion of the image data to the driver circuit. In some implementations, the display apparatus can include an image source module capable of sending the image data to the processor. The image source module can include at least one of a receiver, transceiver, and transmitter. The display apparatus also can include an input device capable of receiving input data and communicating the input data to the processor.

Another innovative aspect of the subject matter described in this disclosure can be implemented in a method of manufacturing a display apparatus. The method can include forming a light blocking layer over a first substrate. The light blocking layer can define a first plurality of apertures each corresponding to a respective display element. The method can include forming a plurality of structural projections over the light blocking layer such that each structural projection includes at least one sidewall positioned adjacent to at least one edge of a respective aperture in the light blocking layer. The sidewalls of the plurality of structural projections can include a reflective material.

In some implementations, the method can include forming an array of light modulators over the first substrate. Each light modulator can correspond to a respective display element. In some implementations, the method can include forming an array of light modulators over the second substrate. Each light modulator corresponding to a respective display element. In some implementations, each structural projection has a height in the range of about 1.5 microns to about 5 microns. In some implementations, each sidewall is oriented at an angle between about 50 degrees and about 90 degrees with respect to a surface of the first substrate.

In some implementations, the method can include coating the sidewalls of the plurality of structural projections with a reflective material by depositing at least one of aluminum, titanium, and silver over the sidewalls of the structural projections and removing the layer of reflective material from a top surface of each structural projection. In some implementations, the method can include coating the sidewalls of the plurality of structural projections with a reflective material by depositing at least one of a dielectric mirror layer and a dielectrically enhanced mirror layer over the sidewalls of the structural projections and removing the layer of reflective material from a top surface of each structural projection. In some implementations, the method can include depositing a light absorbing material on a top surface of each structural projection.

In some implementations, the method can include forming a second light blocking layer over the second substrate. The second light blocking layer can define a second plurality of apertures each corresponding to a respective display element. The method can include forming a second plurality of structural projections over the second light blocking layer such that each structural projection includes at least one sidewall positioned adjacent to at least one edge of a respective aperture in the light blocking layer. The method can include coating the sidewalls of the second plurality of structural projections with a reflective material.

Another innovative aspect of the subject matter described in this disclosure can be implemented in an apparatus. The apparatus can include a first substrate, a second substrate substantially parallel to the first substrate, and an array of light modulating means between the first substrate and the second substrate. The apparatus can include a first light blocking means on the first substrate and defining a first plurality of apertures. The apparatus can include a second light blocking means on the second substrate and defining a second plurality of apertures. Each of the second plurality of apertures can be aligned with a respective aperture in the first plurality of apertures. The apparatus can include a plurality of light reflecting means each adjacent to at least one edge of a respective aperture of the first plurality of apertures and between the first and second substrates.

In some implementations, each of the plurality of light reflecting means is oriented at an angle between about 50 degrees and about 90 degrees with respect to a surface of the first substrate. In some implementations, the plurality of light reflecting means includes light reflecting means positioned adjacent to a longer edge of each aperture of the first plurality of apertures.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS)-based display apparatus.

FIG. 1B shows a block diagram of an example host device.

FIGS. 2A and 2B show views of an example dual actuator shutter assembly.

FIG. 3 shows a cross-sectional view of an example display device.

FIG. 4A shows a cross-sectional view of an example display device with collimating structures.

FIG. 4B shows a cross-sectional view of another example display device with collimating structures.

FIG. 4C shows a cross-sectional view of another example display device with collimating structures.

FIG. 4D shows a cross-sectional view of another example display device with collimating structures.

FIG. 4E shows a cross-sectional view of another example display device with collimating structures.

FIG. 5 shows a flow chart of an example process for manufacturing a display device with collimating structures.

FIGS. 6A-6L show cross-sectional views of stages of construction of an example display device according to the manufacturing process shown in FIG. 5.

FIGS. 7A-7F show cross-sectional views of stages of construction of another example display device that can be manufactured according to the manufacturing process shown in FIG. 5.

FIGS. 8A and 8B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

A display device can produce images by modulating light using an array of display elements. The array of display elements can include MEMS shutter-based light modulators positioned between a front substrate and a rear substrate. Light blocking layers defining apertures corresponding to the light modulators can be positioned on each of the front substrate and the rear substrate. A backlight can be positioned behind the rear substrate. Light emitted from the backlight can be modulated by the light modulators as it travels along an optical path between the apertures in the rear light blocking layer and the apertures in the front light blocking layer. Typically, light passing through a display element at higher angles may be blocked by the front light blocking layer, even when the shutter associated with the display element is in an open position. This type of light loss is sometimes referred to as “clipping loss.” Because the apertures in the light blocking layers are typically longer along one axis of the display than along a second axis perpendicular to the first axis, clipping loss can substantially reduce the viewing angle of the display along the second, shorter axis. Such displays also can exhibit light leakage between adjacent display elements, reducing the contrast ratio of the display.

The angular distribution of light, as well as the total light throughput, can be increased by incorporating collimating structures around the edges of the apertures in the light blocking layers. For example, collimating structures can include reflective sidewalls positioned adjacent to the edges of the apertures in the light blocking layers. The reflective sidewalls can reflect high angle light rays, which otherwise may be blocked by the front light blocking layer or leak into adjacent display elements, through the front apertures. As a result, the angular distribution of light can be improved, particularly along the shorter axis of the apertures, and the total light throughput of the display device can be increased.

In some implementations, collimating structures can be positioned around the apertures in the front light blocking layer or around apertures in the rear light blocking layer. In some other implementations, collimating structures can be positioned around the apertures in both the front and the rear light blocking layers. Collimating structures positioned on the rear substrate can include a reflective material on their rear-facing surfaces to reflect off-axis light back into the backlight, where it can be recycled. The front-facing surfaces of the collimating structures can be configured to absorb light, which can improve the contrast ratio of the display device by reducing ambient light reflection.

Particular implementations of the subject matter described in this disclosure can be implemented to realize one or more of the following potential advantages. Positioning collimating structures around the edges of apertures in light blocking layers can improve the angular distribution of light in a display device. For example, light rays passing at high angles are often clipped by the front light blocking layer, particularly along the shorter axis of the apertures. Collimating structures can include sidewall reflectors configured to reflect high-angle light, which otherwise would be clipped, back towards the opposite edge of the optical path between the apertures in the front and rear light blocking layers. Thus, light can exit the display at higher angles along the shorter axis of the apertures. As a result, viewing angles along the shorter axis can be improved. Furthermore, collimating structures with sidewall reflectors also can reflect lower-angle light, resulting in increased on-axis brightness. Together, the reduction of clipping loss and the increase in on-axis light throughput results in higher total light throughput. A display incorporating collimating light structures can therefore achieve a higher brightness level, or can be operated at a lower power while achieving a similar level of brightness as a higher-powered display.

Incorporating collimating structures into a display device around the edges of apertures in light blocking layers also can allow for the spacing between the front and rear substrates (sometimes referred to as the cell gap) to be increased. Increasing the cell gap elongates the optical paths between apertures in the rear light blocking layer and corresponding apertures in the front light blocking layer. This can lead to increased light leakage, lower contrast ratio, reduced viewing angles, and increased clipping loss (lower light efficiency). Collimating structures can reduce light leakage (improve contrast ratio), increase viewing angles, and decrease clipping loss, thereby allowing the cell gap to be increased without substantially interfering with the optical performance of the display device. Some display devices include a fluid sealed between the substrates and surrounding the light modulators. Increasing the cell gap reduces the fluid resistance experienced by the shutters of the light modulators, allowing the shutters to actuate faster and at lower power. Thus, by allowing for an increased cell gap, collimating structures also can lead to increased shutter actuation speed and decreased power consumption of a display device.

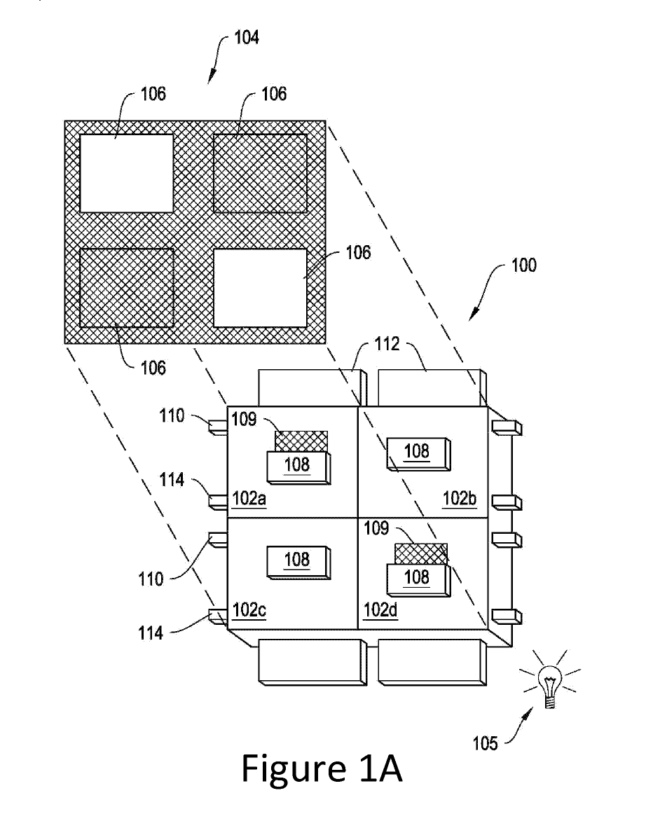

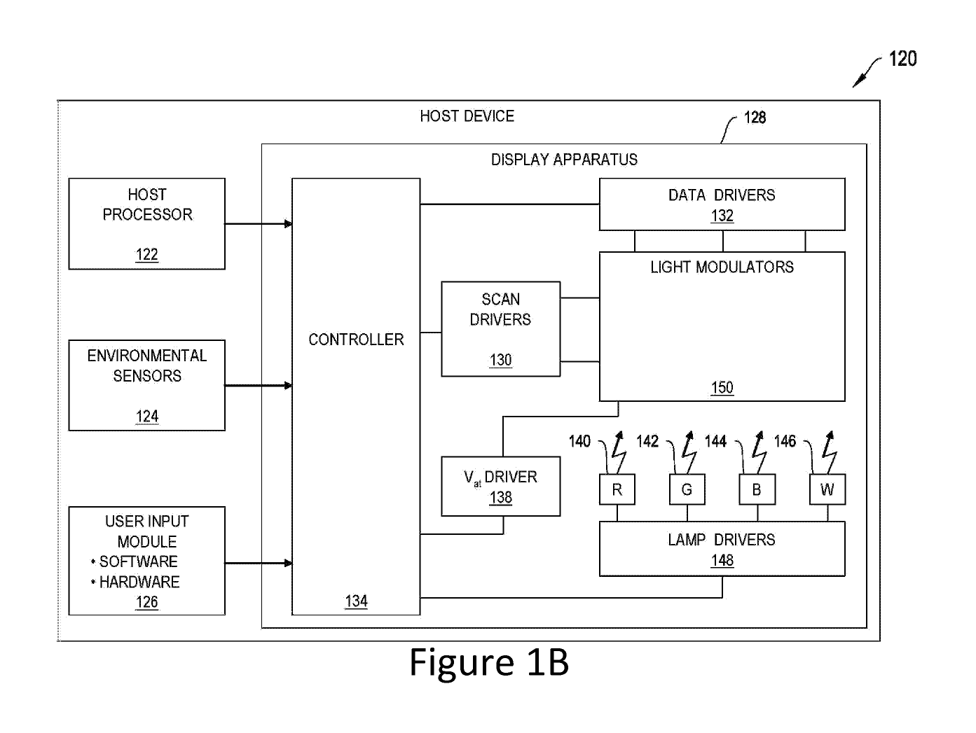

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness of the display, the contrast of the display, or both.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; instructions for the display apparatus 128 for use in selecting an imaging mode; or any combination of these types of information.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

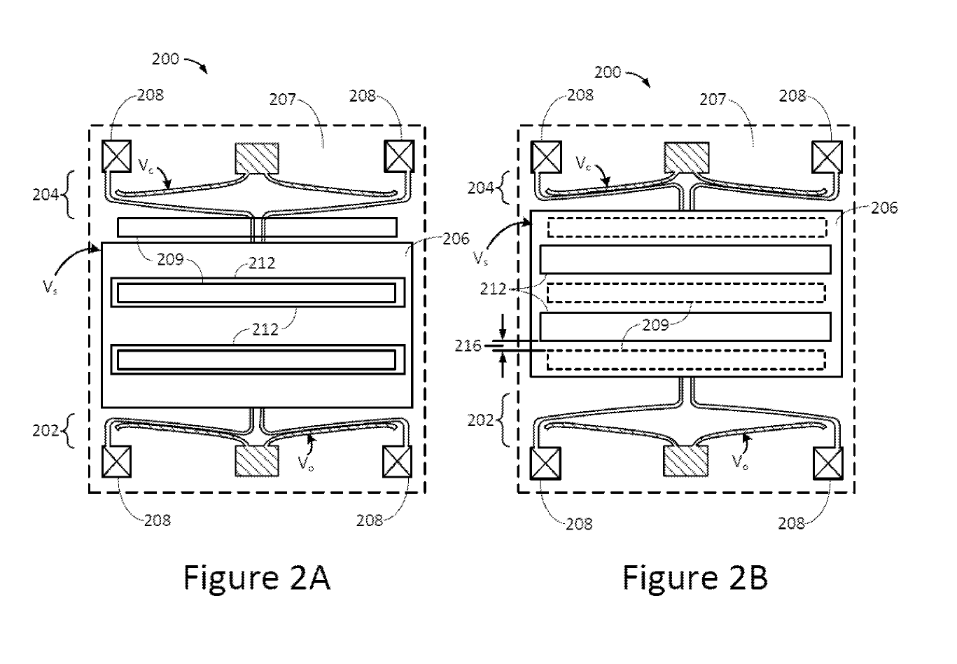

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

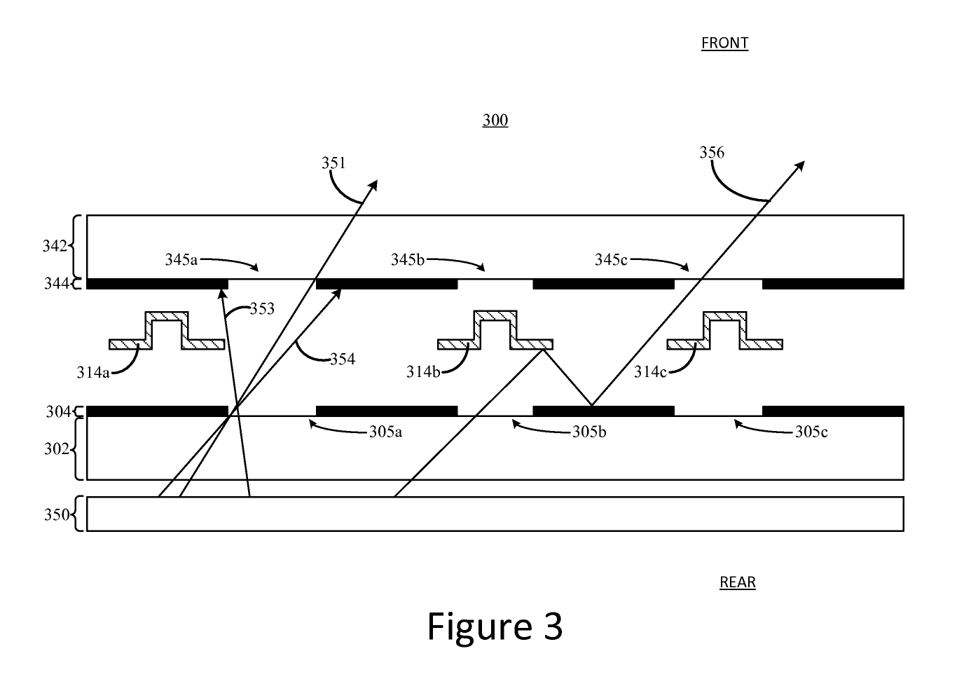

FIG. 3 shows a cross-sectional view of an example display device 300. The display device 300 includes a rear substrate 302 on which a rear light blocking layer 304 is deposited. The rear light blocking layer 304 includes several rear apertures 305a-305c (generally referred to as rear apertures 305). Each rear aperture 305 corresponds to a respective display element of the display device 300. The display device 300 also includes a front substrate 342 on which a front light blocking layer 344 is deposited. The front light blocking layer 344 includes several front apertures 345a-345c (generally referred to as front apertures 345). Each front aperture 345 corresponds to a respective display element of the display device 300, and is aligned with a respective rear aperture 305. Shutters 314a-314c (generally referred to as shutters 314) are suspended between the rear light blocking layer 304 and the front light blocking layer 344. Each shutter 314 also is associated with a respective display element. A backlight 350 is positioned behind the rear substrate 302 and configured to emit light towards the front side of the display device 300. The shutters 314 move into and out of the optical paths defined between their respective rear apertures 305 and front apertures 345 to modulate light, thereby forming an image on the display device 300. The shutter 314a is shown in an open position, in which it does not obstruct the optical path between its respective rear aperture 305a and its respective front aperture 345a. The shutters 314b and 314c are shown in their respective closed positions.

The display device 300 suffers from clipping loss (as illustrated by the light ray 354). For example, the high angle light ray 354 exits the backlight 350 and passes through the rear aperture 305a. The shutter 314a is in an open position, permitting the high angle light ray 354 to pass towards the front of the display device 300. However, because the high angle light ray 354 passes through the rear aperture 305a at a relatively high angle, it is absorbed, or “clipped,” by the front light blocking layer 344. In contrast, the direct passage light ray 351 passes through the rear aperture 305a and the same point as the high angle light ray 354, but is able to exit the display device 300 through the front aperture 345a without being clipped, due to its lower angle. This direct passage light ray 351 enters the rear aperture 305a at the leftmost edge of the rear aperture 305a, and exits the front aperture 345a at the rightmost edge of the front aperture 345a. Thus, the direct passage light ray 351 illustrates the highest possible angle at which a light ray originating from the backlight 350 can exit the display device 300 without reflective off of an interior surface. In general, light rays can be referred to as “high angle” light rays if they pass through the rear aperture 305a at an angle higher than the highest angle possible for a direct passage light ray. The value of this angle will depend on the sizes of the apertures 305 and 345 and the distance between the rear substrate 302 and the front substrate 342 of a given implementation. High angle light rays, like the high angle light ray 354, cannot exit the display device without reflecting off of an interior surface of the display device 300. It should be understood that some lower angle light rays also can be clipped. For example, the angle of the light ray 353 is lower than the angle of the direct passage light ray 351. However, the low-angle light ray 353 is clipped by the front light blocking layer 344, while the direct passage light ray 351 is not.

The high angle light ray 354 that is blocked by the front light blocking layer 344 is not able to contribute to the formation of an image, even when the shutter 314a is in an open position. An observer will therefore perceive the display device 300 as having a lower brightness overall, because some of the light emitted by the backlight 350 is clipped by the front light blocking layer 344. Moreover, the angular distribution of light in the display device 300 may be non-uniform, which can reduce the viewing angle along at least one axis of the display device 300. For example, the front apertures 345 may be significantly longer than they are wide. In some implementations, the front apertures 345 may have a shape similar to the shape of the aperture layer apertures 209 shown in FIGS. 2A and 2B. Typically, the front apertures 345 are shorter in the direction of shutter motion (i.e., the left-to-right axis of the display device 300 shown in FIG. 3) and are longer along a perpendicular direction (i.e., the direction perpendicular to the plane of the page). In some implementations, the front apertures 345 may be between about four times longer than they are wide and about six times longer than they are wide. For example, the front apertures 345 may have lengths in the range of about 60 microns to about 100 microns, and widths in the range of about 12 microns to about 20 microns. Similar dimensions and length-to-width ratios also may apply to the rear apertures 305. Thus, clipping loss is greater along the shorter axis of the front apertures 345, and the display device 300 therefore may appear significantly less bright when viewed along that axis. This can be especially problematic in implementations in which the display device 300 is incorporated into a handheld computing device, such as a smartphone, tablet or wearable device, which often may be rotated by a user to view the display device 300 from different angles.

The display device 300 also exhibits light leakage between adjacent display elements, as illustrated by the high angle light ray 356. Light leakage occurs when light passing through the rear aperture 305 of a first display element reflects off of one or more surfaces within the display device 300 and exits the display device 300 through the front aperture 345 of a second display element. For example, the high angle light ray 356 passes through the rear aperture 305b, reflects off of the shutter 314b and the rear light blocking layer 304, and exits the display device 300 through the front aperture 345c. This type of light leakage can reduce the quality of images formed by the display device 300, particularly when light leaks out of the front aperture 345 of a display element whose shutter (like the shutter 314c) is in a closed position. Such light leakage increases the brightness of a display element that should appear dark, thereby decreasing the contrast ratio of the display device 300. While light leakage is illustrated with the high angle light ray 356 in FIG. 3, it should be understood that, in some implementations, low angle light rays also may reflect off of interior surfaces of the display device 300 and escape through the front apertures 345 or adjacent display elements, thereby further contributing to light leakage.

One technique for reducing clipping loss and light leakage in the display device 300 is to decrease the distance between the rear light blocking layer 304 and the front light blocking layer 344. This distance is sometimes referred to as the cell gap. However, in some implementations, the shutters 314 are surrounded by a fluid. For example, in some implementations the shutters 314 can be surrounded by oil, such as a silicone oil, a fluorine oil, another oil, or another type of liquid. In some implementations, the shutters 314 can be surrounded by a gas, such as nitrogen or air. Reducing the cell gap means that the shutters 314 are positioned closer to the rear light blocking layer 304 and the front light blocking layer 344, which increases the fluid resistance experienced by the shutters 314 as they actuate between closed and open positions. This increased fluid resistance can slow the speed of shutter actuation and increase the power necessary to actuate the shutters 314 at sufficiently fast rates. Thus, in some implementations, it is desirable to increase the cell gap in order to improve shutter actuation speed. However, as discussed above, increasing the cell gap can worsen the problems of clipping loss and light leakage. In some implementations, collimating structures can be added to a display device in order to increase the cell gap while also reducing clipping loss and light leakage, as described further below.

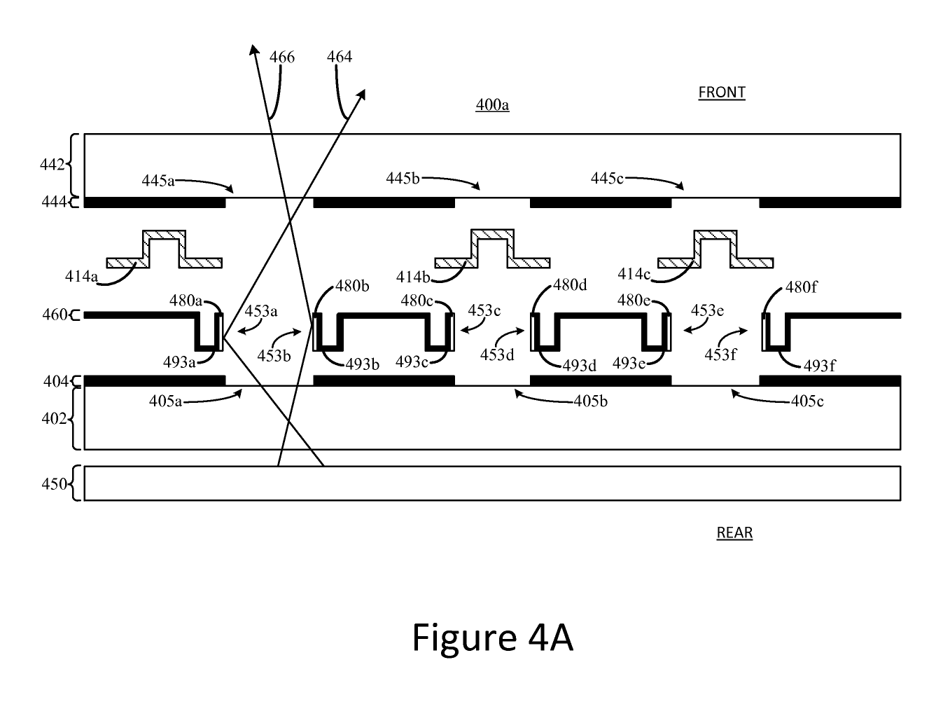

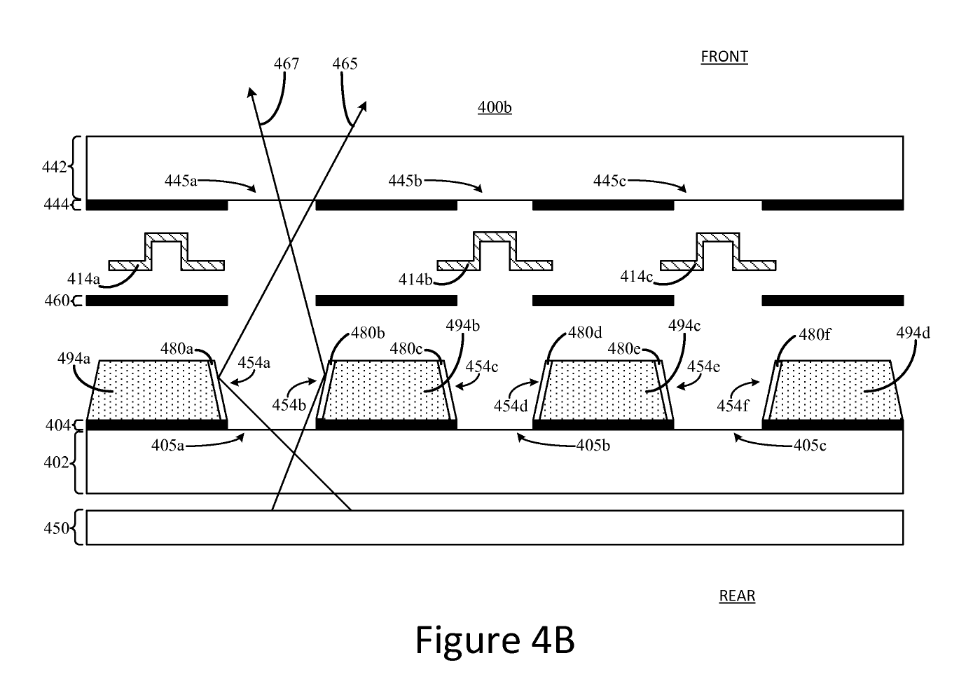

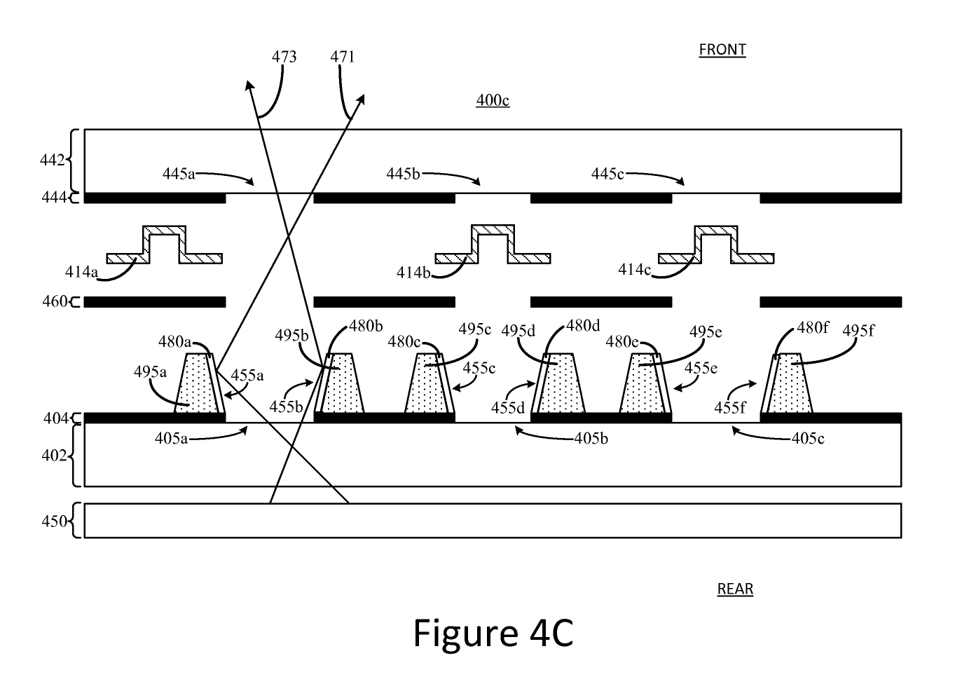

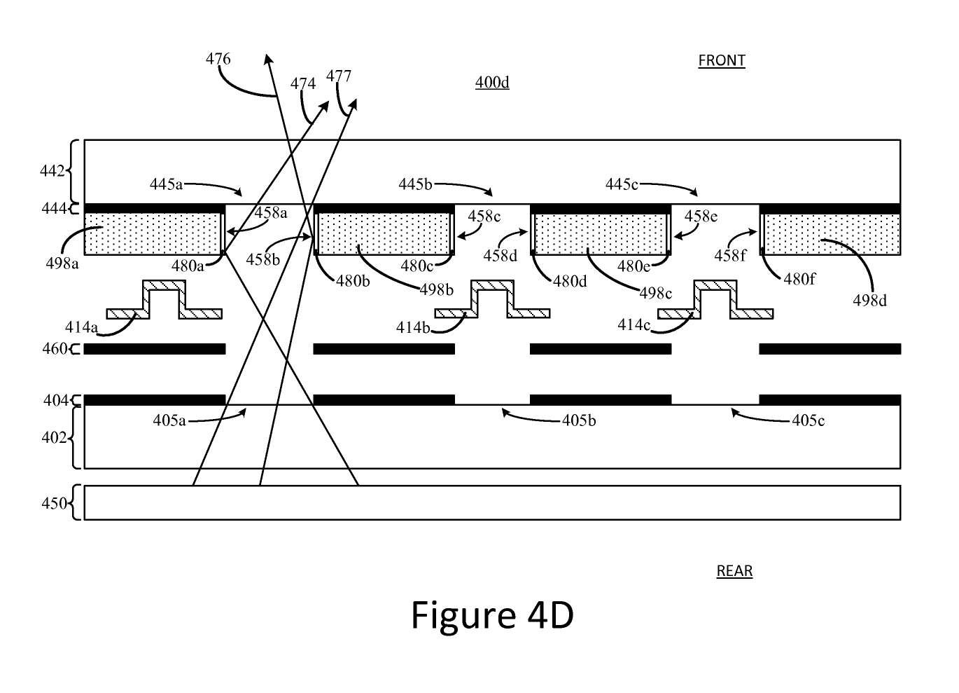

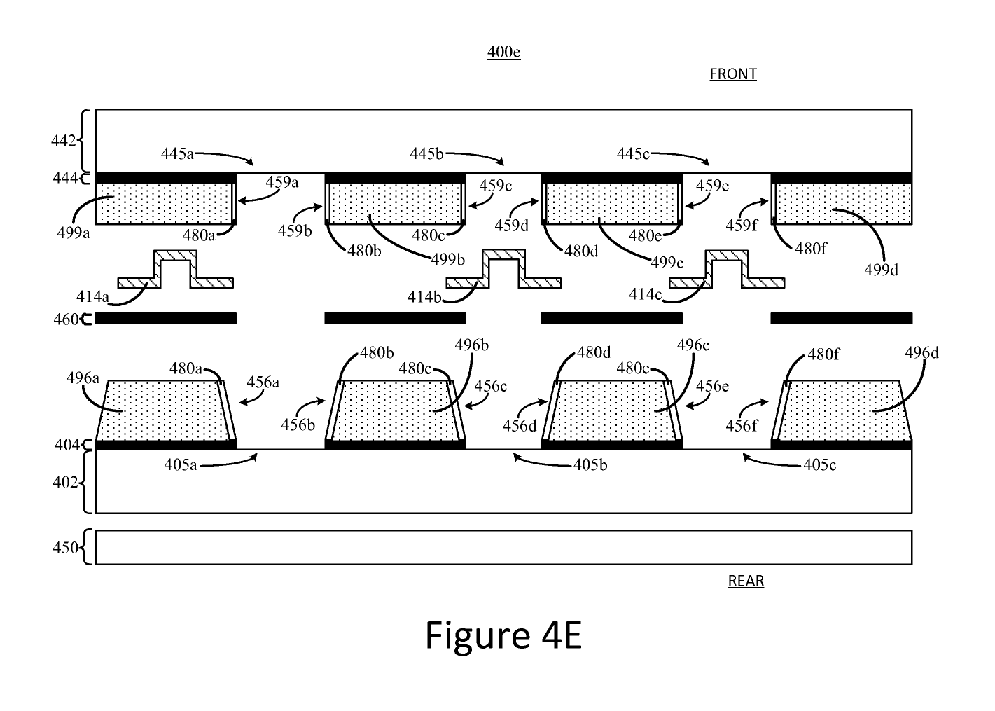

FIG. 4A shows a cross-sectional view of an example display device 400a with collimating structures 453a-453f (generally referred to as collimating structures 453). The display device 400a includes many elements similar to those of the display device 300 shown in FIG. 3. The display device 400a includes a rear (or first) substrate 402 on which a rear light blocking layer 404 is deposited. The rear light blocking layer 404 includes several rear apertures 405a-405c (generally referred to as rear apertures 405). Each rear aperture 405 corresponds to a respective display element of the display device 400a. The display device 400a also includes a front (or second) substrate 442 on which a front light blocking layer 444 is deposited. The front light blocking layer 444 includes several front apertures 445a-445c (generally referred to as front apertures 445). Each front aperture 445 corresponds to a respective display element of the display device 400a and is aligned with a respective rear aperture 405. Shutters 414a-414c (generally referred to as shutters 414) are suspended between the rear light blocking layer 404 and the front light blocking layer 444. Each shutter 414 can be associated with a respective display element. A backlight 450 is positioned behind the rear substrate 402 and emits light towards the front side of the display device 400a. The shutters 414 move into and out of the optical paths defined between their respective rear apertures 405 and front apertures 445 to modulate light, thereby forming an image on the display device 400a. The shutter 414a is shown in an open position, while the shutters 414b and 414c are shown in their respective closed positions.

The display device 400a also includes an aperture layer 460 positioned between the rear light blocking layer 404 and the front light blocking layer 444, and collimating structures 453 positioned over the rear light blocking layer 404. Each collimating structure 453 includes a respective structural projection 493a-493f (generally referred to as structural projections 493) and a sidewall 480a-480f (generally referred to as sidewalls 480). The structural projections 493 are part of the aperture layer 460. Each rear aperture 405 is surrounded by a respective pair of collimating structures 453. The collimating structures 453 can help to reduce clipping loss in the display device 400a. For example, the sidewalls 480 of the collimating structures 453 are positioned adjacent to respective rear apertures 405. The sidewalls 480 of the collimating structures 453 can be reflective, such that high angle light originating from the backlight 450 can reflect off of the sidewalls 480 of the collimating structures 453 and be directed towards the front apertures 445.

The light rays 464 and 466 illustrate the reduction in clipping loss that can be achieved due to the collimating structures 453. For example, the light ray 464 is emitted by the backlight 450 and directed through the rear aperture 405a at a relatively high angle. Due to its high angle, the light ray 464 would either be clipped by the aperture layer 460 or the front light blocking layer 444, or would leak out of an adjacent display element, if the collimating structures 453 were not included in the display device 400a. However, including the collimating structures 453 puts the reflective sidewall 480a of the collimating structure 453a in the optical path of the light ray 464. As a result, the light ray 464 is reflected back towards the opposite side of the front aperture 445a, where it exits the display device 400a and contributes to the formation of an image. The light ray 464 is able to exit the display device 400a at an angle higher than would be possible for a direct light ray to pass, and therefore the angular distribution of light in the display device 400a is improved.

The light ray 466 passes through the rear aperture 405 at a relatively low angle. However, because it passes through the rear aperture 405a near the right edge of the aperture 405a, the light ray 466 still would be clipped by either the aperture layer 460 or the front light blocking layer 444, or could leak out of an adjacent display element, if the collimating structures 453 were not included in the display device 400a. The reflective sidewall 480b of the collimating structure 453a reflects the light ray 466 back towards the opposite side of the front aperture 445a, where it exits the display device 400a. Thus, because the light ray 466 would not be able to pass through the front aperture 445a if the collimating structures 453 were absent, the presence of the collimating structures 453 also increases the amount of low angle light that is able to exit the display device through the front apertures 445. As such, the incorporation of the collimating structures 453 in the display device 400a results in an increase in the total light throughput of the display device 400a. As a result, the display device 400a can appear to have an increased brightness level relative to a display device in which collimating structures 453 having reflective sidewalls 480 are not included, without any increase in the light output of the backlight 450.

In some implementations, the reflective sidewalls 480 of the collimating structures 453 also can reduce light leakage in the display device 400a. For example, light leakage often results from high angle light rays that reflect off of interior surfaces in a display device before exiting through the front aperture 445 of an adjacent display element. The reflective sidewalls 480 of the collimating structures 453 are positioned in the optical paths of high angle light rays, which can help to prevent light leakage. The aperture layer 460 can include a light absorbing material to absorb off-axis light that is not blocked by the collimating structures 453, thereby further reducing light leakage.

In some implementations, the collimating structures 453 may be included on the longer edges of the rear apertures 405. As discussed above, the angular distribution of light is typically less uniform along the axis that is parallel to the shorter sides of the front apertures 445 and rear aperture 405. Positioning the collimating structures 453 along the longer edges of the rear apertures 405 increases the probability that light rays traveling parallel to the short axis will be reflected by the reflective sidewalls 480 of the collimating structures 453, thereby improving the angular distribution of light along the shorter axis. In some other implementations, the collimating structures 453 can be positioned along both the longer edges and the shorter edges of the rear apertures 405. For example, the collimating structures 453 can substantially surround the rear apertures 405.

In some implementations, including the collimating structures 453 in the display device 400a can allow the cell gap of the display device 400a to be increased without substantially increasing clipping loss or light leakage. As discussed above, the reflective sidewalls 480 of the collimating structures 453 can reflect light rays that otherwise would be clipped or leak into adjacent display elements back towards the opposite side of the respective front apertures 445. Thus, the inclusion of the collimating structures 453 with reflective sidewalls 480 can allow the optical paths between the rear apertures 405 and the front aperture 445 to be lengthened without substantially increasing clipping loss or light leakage, because the sidewalls 480 of the collimating structures 453 are able to reflect light that otherwise would be clipped or leak into adjacent display elements.

FIG. 4B shows a cross-sectional view of another example display device 400b with collimating structures 454a-454d (generally referred to as collimating structures 454). The display device 400b includes many elements similar to those of the display device 400a shown in FIG. 4A. For example, the display device 400b includes a rear substrate 402 on which a rear light blocking layer 404 is deposited. the rear light blocking layer 404 includes several rear apertures 405a-405c (generally referred to as rear apertures 405). Each rear aperture 405 corresponds to a respective display element of the display device 400b. The display device 400b also includes a front substrate 442 on which a front light blocking layer 444 is deposited. The front light blocking layer 444 includes several front apertures 445a-445c (generally referred to as front apertures 445). Each front aperture 445 corresponds to a respective display element of the display device 400b and is aligned with a respective rear aperture 405. Shutters 414a-414c (generally referred to as shutters 414) are suspended between the rear light blocking layer 404 and the front light blocking layer 444. Each shutter 414 is associated with a respective display element. A backlight 450 is positioned behind the rear substrate 402 and emits light towards the front side of the display device 400b. The shutters 414 move into and out of the optical paths defined between their respective rear apertures 405 and front apertures 445 to modulate light, thereby forming an image on the display device 400b. The shutter 414a is shown in an open position, while the shutters 414b and 414c are shown in their respective closed positions.

The display device 400b differs from the display device 400a in that the display device 400b includes collimating structures 454 positioned on the rear facing surface of the rear light blocking layer 404, rather than as part of the aperture layer 460. Each collimating structure 454 spans the distance between a pair of rear apertures 405. The collimating structures 454 include structural projections 494a-494d (generally referred to as structural projections 494), which have sloped surfaces covered by angled reflective sidewalls 480.

The reflective sidewalls 480 of the collimating structures 454 are angled away from the edges of the rear apertures 405, and can serve to reflect light that would otherwise be clipped through the front apertures 445, as illustrated by the high angle light ray 465 and the low angle light ray 467. In some implementations, the angle of the reflective sidewalls 480 can be selected to achieve a desired angular distribution of light in the display device 400b. The angle selected for the reflective sidewalls 480 can be a function of the cell gap, the length to width ratio of the rear apertures 405, and the distance separating adjacent display elements in the display device 400b. In some implementations, the reflective sidewalls 480 of the collimating structures 454 can be substantially perpendicular to the light blocking layer 404. In some implementations, the angle of the reflective sidewalls 480 of the collimating structures 454 can be between about 45 degrees and about 90 degrees with respect to the rear light blocking layer 404. In some other implementations, the angle of the reflective sidewalls 480 of the collimating structures 454 can be between about 60 degrees and about 85 degrees or between about 70 degrees and about 80 degrees with respect to the rear light blocking layer 404. As shown, the collimating structures 454 extend away from the rear substrate 402. In some implementations, the collimating structures 454 can have a height in the range of about 1 micron to about 5 microns. In some other implementations, the collimating structures 454 can have a height in the range of about 1.5 microns to about 2.5 microns.

The top and bottom surfaces of the structural projections 494 that form portions of the collimating structures 454 also can be configured to improve the light management capabilities of the display device 400b. For example, as shown in FIG. 4B, the rear facing surface of the structural projections 494 can include, or be in contact with, a light blocking material, such as the rear light blocking layer 404. In some other implementations, the rear facing surface of the structural projections 494 can be made from a reflective material, such that light directed towards the rear surface of the structural projections 494 can be reflected back into the backlight 450, where it can be recycled. The front facing surfaces of the structural projections 494 can be configured to absorb light. For example, in some implementations, the structural projections 494 can be include a light absorbing material such as dark spin-on-glass or a light absorbing dielectric. In some other implementations, the structural projections 494 can be coated with a light absorbing material. This can help to prevent light leakage by reducing the amount of light that reflects off of internal surfaces within the display device 400b.

FIG. 4C shows a cross-sectional view of another example display device 400c with collimating structures 455a-455f (generally referred to as collimating structures 455). The display device 400c includes many elements similar to those of the display device 400b shown in FIG. 4B. For example, the display device 400c includes a rear substrate 402 on which a rear light blocking layer 404 is deposited. The rear light blocking layer 404 includes several rear apertures 405a-405c (generally referred to as rear apertures 405). Each rear aperture 405 corresponds to a respective display element of the display device 400c. The display device 400c also includes a front substrate 442 on which a front light blocking layer 444 is deposited. The front light blocking layer 444 includes several front apertures 445a-445c (generally referred to as front apertures 445). Each front aperture 445 corresponds to a respective display element of the display device 400c and is aligned with a respective rear aperture 405. Shutters 414a-414c (generally referred to as shutters 414) are suspended between the rear light blocking layer 404 and the front light blocking layer 444. Each shutter 414 is associated with a respective display element. A backlight 450 is positioned behind the rear substrate 402 and emits light towards the front side of the display device 400c. The shutters 414 move into and out of the optical paths defined between their respective rear apertures 405 and front apertures 445 to modulate light, thereby forming an image on the display device 400c. The shutter 414a is shown in an open position, while the shutters 414b and 414c are shown in their respective closed positions.

The display device 400c differs from the display device 400b in that the display device 400c includes collimating structures 455 that are narrower than the collimating structures 454 shown in the display device 400b of FIG. 4B. In the display device 400c, each front aperture 445 is surrounded by a respective pair of collimating structures 455, and adjacent collimating structures 455 are separated by a gap. The collimating structures 455 include structural projections 495a-495f (generally referred to as structural projections 495), which have reflective sidewalls 480 that can help to reduce clipping loss in the display device 400c in a manner similar to that of the collimating structures 454 shown in FIG. 4B, as illustrated by the high angle light ray 471 and the low angle light ray 473.

The collimating structures 455 can have side surfaces that are angled as discussed above in connection with the collimating structures 455 shown in FIG. 4B. In some implementations, the width of each collimating structure 455 can be significantly smaller than the distance between adjacent rear apertures 405. For example, the width of each collimating structure 455 can be in the range of about 3 microns to about 25 microns. In some other implementations, the width of each collimating structure 455 can be in the range of about 5 microns to about 15 microns. In some implementations, the width of each collimating structure 455 can be about 10 microns. The collimating structures 455 can be positioned along the longer edges of the rear apertures 405, to increase the probability that light rays traveling parallel to the short axis will be reflected by the reflective sidewalls 480 of the collimating structures 455, thereby improving the angular distribution of light along the shorter axis. In some other implementations, the collimating structures 455 can be positioned along both the longer edges and the shorter edges of the rear apertures 405. For example, the collimating structures 455 can substantially surround the rear apertures 405.

FIG. 4D shows a cross-sectional view of another example display device 400d with collimating structures 458a-458d (generally referred to as collimating structures 458). The display device 400d includes many elements similar to those of the display devices 400a-400c shown in FIGS. 4A-4C, respectively. For example, the display device 400d includes a rear substrate 402 on which a rear light blocking layer 404 is deposited. The rear light blocking layer 404 includes several rear apertures 405a-405c (generally referred to as rear apertures 405). Each rear aperture 405 corresponds to a respective display element of the display device 400d. The display device 400d also includes a front substrate 442 on which a front light blocking layer 444 is deposited. The front light blocking layer 444 includes several front apertures 445a-445c (generally referred to as front apertures 445). Each front aperture 445 corresponds to a respective display element of the display device 400d and is aligned with a respective rear aperture 405. Shutters 414a-414c (generally referred to as shutters 414) are suspended between the rear light blocking layer 404 and the front light blocking layer 444. Each shutter 414 is associated with a respective display element. A backlight 450 is positioned behind the rear substrate 402 and emits light towards the front side of the display device 400d. The shutters 414 move into and out of the optical paths defined between their respective rear apertures 405 and front apertures 445 to modulate light, thereby forming an image on the display device 400d. The shutter 414a is shown in an open position, while the shutters 414b and 414c are shown in their respective closed positions.

The display device 400d differs from the display devices 400a-400c in that the display device 400d includes collimating structures 458 positioned over the front light blocking layer 444, rather than over the rear light blocking layer 404. In the display device 400d, each front aperture 445 is surrounded by a respective pair of collimating structures 458. The collimating structures 458 can help to reduce clipping loss in the display device 400d.

The collimating structures 458 include structural projections 498a-498d (generally referred to as structural projections 498), which have sidewalls 480 positioned adjacent to respective front apertures 445. The sidewalls 480 can be reflective, such that light originating from the backlight 450 can reflect off of the sidewalls 480 and be directed towards the front apertures 445. The light rays 474 and 476 illustrate the reduction in clipping loss that can be achieved due to the collimating structures 458. For example, the light ray 474 is emitted by the backlight 450 and directed through the rear aperture 405a at a relatively high angle. Due to its high angle, the light ray 474 would be clipped by the front light blocking layer 444, if the collimating structures 458 were not included in the display device 400d. However, including the collimating structures 458 puts the reflective sidewall 480a of the collimating structure 458a in the optical path of the light ray 474. As a result, the light ray 474 is reflected back towards the opposite side of the front aperture 445a, where it exits the display device 400d and contributes to the formation of an image. The light ray 474 is able to exit the display device 400d at an angle higher than would be possible for a direct light ray to pass, and therefore the angular distribution of light in the display device 400d is improved. For example, the direct passage light ray 477 illustrates the highest angle at which light would be able to exit the display device 400d without reflecting off of an internal surface, such as the reflective sidewalls 480. As illustrated in FIG. 4D, including the reflective sidewalls 480 allows light rays, such as the light ray 474, to exit the display at angles higher than the direct passage light ray 477.

Similarly, the light ray 476 passes through the rear aperture 405 at a relatively low angle. However, because it passes through the rear aperture 405a near the right edge of the aperture 405a, the light ray 476 still would be clipped by either the aperture layer 460 or the front light blocking layer 444, or could leak out of an adjacent display element, if the collimating structures 458 were not included in the display device 400d. The reflective sidewall 480b of the collimating structure 458b reflects the light ray 476 back towards the opposite side of the front aperture 445a, where it exits the display device 400d. Because the low angle light ray 476 and the high angle light ray 474 would not be able to pass through the front aperture 445a if the collimating structures 458 were absent, the presence of the collimating structures 458 also increases the total light throughput of the display device 400d. Thus, the display device 400d can appear to have an increased brightness level relative to a display device in which collimating structures 458 are not included, without any increase in the light output of the backlight 450. Alternatively, the display device 400d can appear to have the same brightness as a display device in which collimating structures 458 are not included, while consuming less power.

In some implementations, the collimating structures 458 can have dimensions similar to those described above in connection with the collimating structures 454 shown in FIG. 4B. For example, the collimating structures 458 can have a height in the range of about 1 micron to about 5 microns. While the reflective sidewalls 480 of the collimating structures 458 are shown perpendicular to the front light blocking layer 444, other angles are also possible. In some implementations, the angle of the reflective sidewalls 480 of the collimating structures 458 can be between about 50 degrees and about 90 degrees with respect to the front light blocking layer 444. In some implementations, the collimating structures 458 can be positioned along the longer edges of the front apertures 445. In some other implementations, the collimating structures can 458 be positioned along both the longer edges and the shorter edges of the front apertures 445. For example, the collimating structures 458 can substantially surround the front apertures 445.

In some implementations, the shutters 414 of the display device 400d can be fabricated over the front substrate 442. The display device 400d can include a backplane positioned over the front substrate 442, which includes circuitry that controls the operation of the shutters 414. In some implementations, the front light blocking layer 444 and the structural projections 498 can form part of the backplane. In some other implementations, the front light blocking layer 444 and the structural projections 498 can be positioned over the backplane. For example, in some implementations the front light blocking layer 444 and the structural projections 498 can include a coated planarization layer including a dielectric material separating metal layers of the backplane.

FIG. 4E shows a cross-sectional view of another example display device 400e with collimating structures 456a-456d (generally referred to as collimating structures 456) and 459a-459d (generally referred to as collimating structures 459). The display device 4003 includes many elements similar to those of the display devices 400a-400d shown in FIGS. 4A-4D, respectively. For example, the display device 400e includes a rear substrate 402 on which a rear light blocking layer 404 is deposited. The rear light blocking layer 404 includes several rear apertures 405a-405c (generally referred to as rear apertures 405). Each rear aperture 405 corresponds to a respective display element of the display device 400e. The display device 400e also includes a front substrate 442 on which a front light blocking layer 444 is deposited. The front light blocking layer 444 includes several front apertures 445a-445c (generally referred to as front apertures 445). Each front aperture 445 corresponds to a respective display element of the display device 400e and is aligned with a respective rear aperture 405. Shutters 414a-414c (generally referred to as shutters 414) are suspended between the rear light blocking layer 404 and the front light blocking layer 444. Each shutter 414 is associated with a respective display element. A backlight 450 is positioned behind the rear substrate 402 and emits light towards the front side of the display device 400e. The shutters 414 move into and out of the optical paths defined between their respective rear apertures 405 and front apertures 445 to modulate light, thereby forming an image on the display device 400e. The shutter 414a is shown in an open position, while the shutters 414b and 414c are shown in their respective closed positions.

The display device 400e differs from the display devices 400a-400d in that the display device 400e includes collimating structures 456 positioned over the rear light blocking layer 404 as well as collimating structures 459 positioned over the front light blocking layer 444. In the display device 400e, each rear aperture 405 is surrounded by a respective pair of collimating structures 456, and each front aperture 445 is surrounded by a respective pair of collimating structures 459. In some implementations, including collimating structures 456 over the rear substrate 402 and collimating structures 459 over the front substrate 442 can further amplify the benefits that may be achieved by including collimating structures on only one of the rear substrate 402 and the front substrate 442. That is, the inclusion of collimating structures on both the rear substrate 402 and the front substrate 442 can result in a display device having higher total light throughput and more uniform angular distribution of light relative to a display device that includes collimating structures on only one of the rear substrate 402 and the front substrate 442.

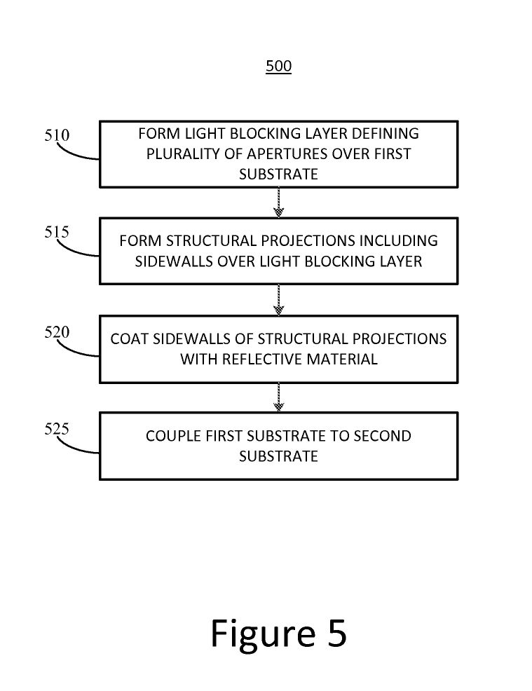

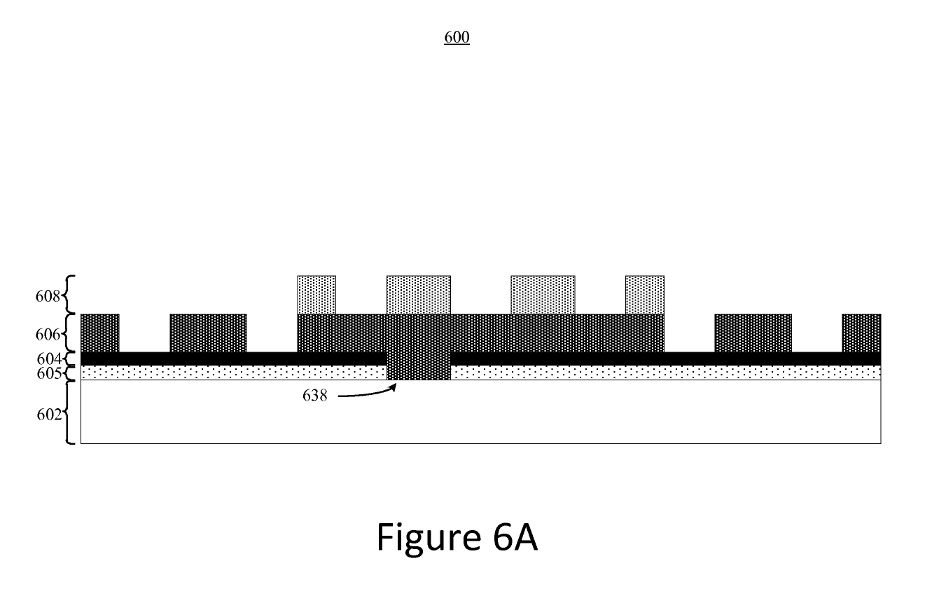

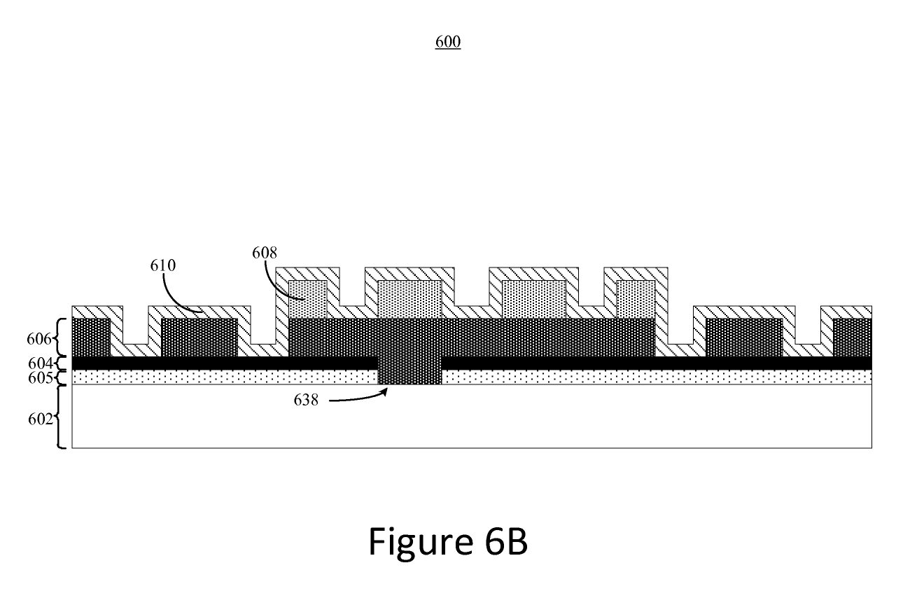

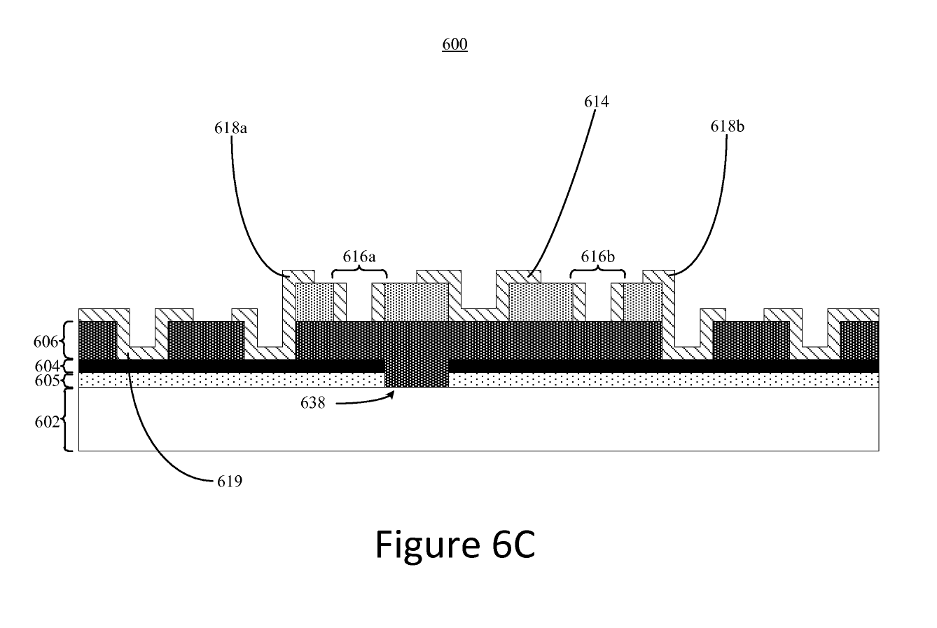

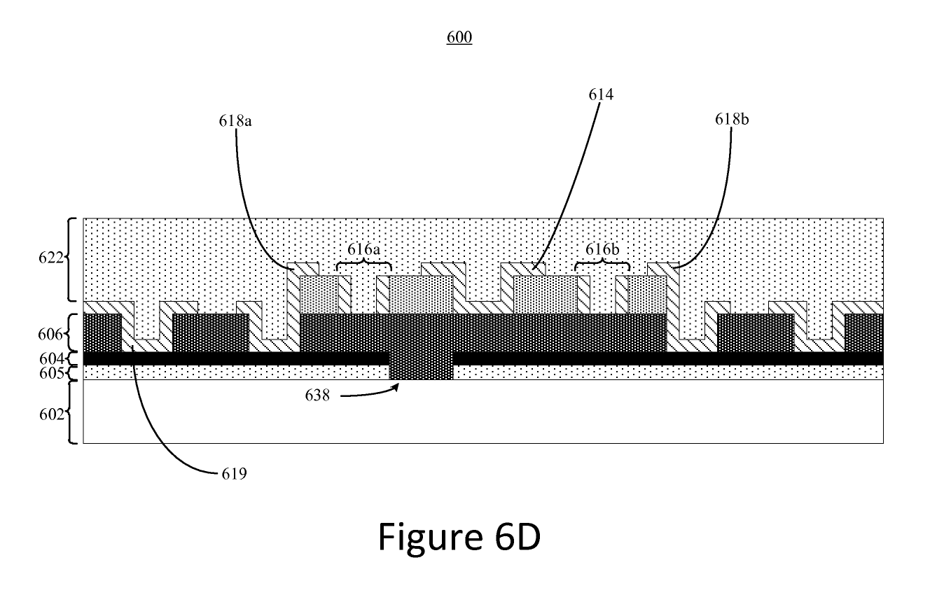

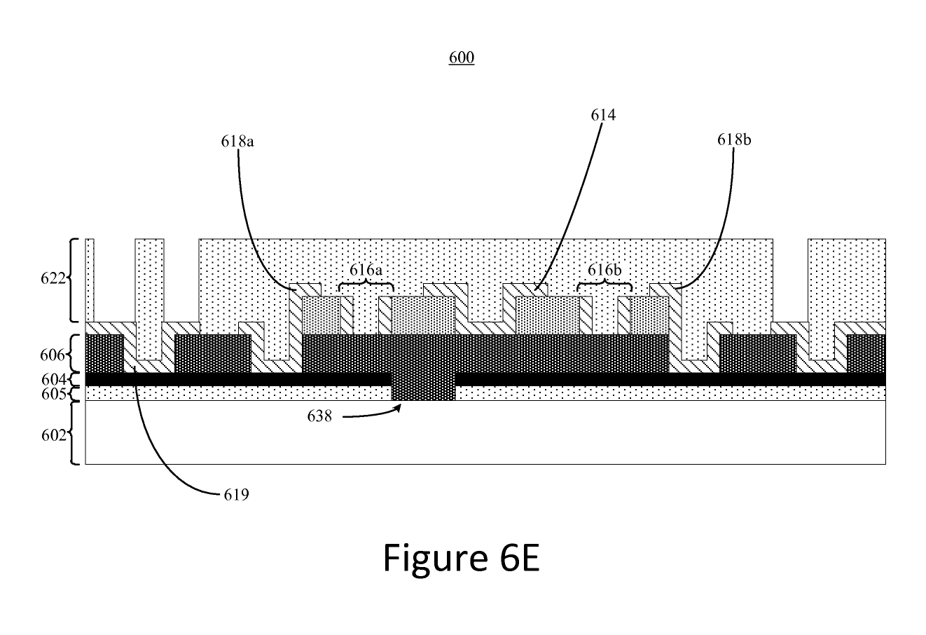

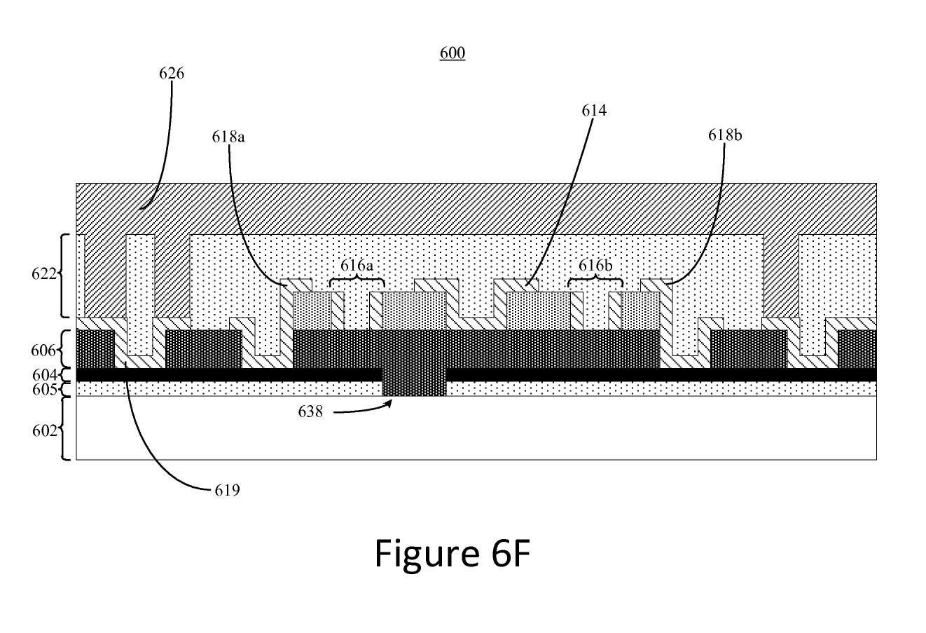

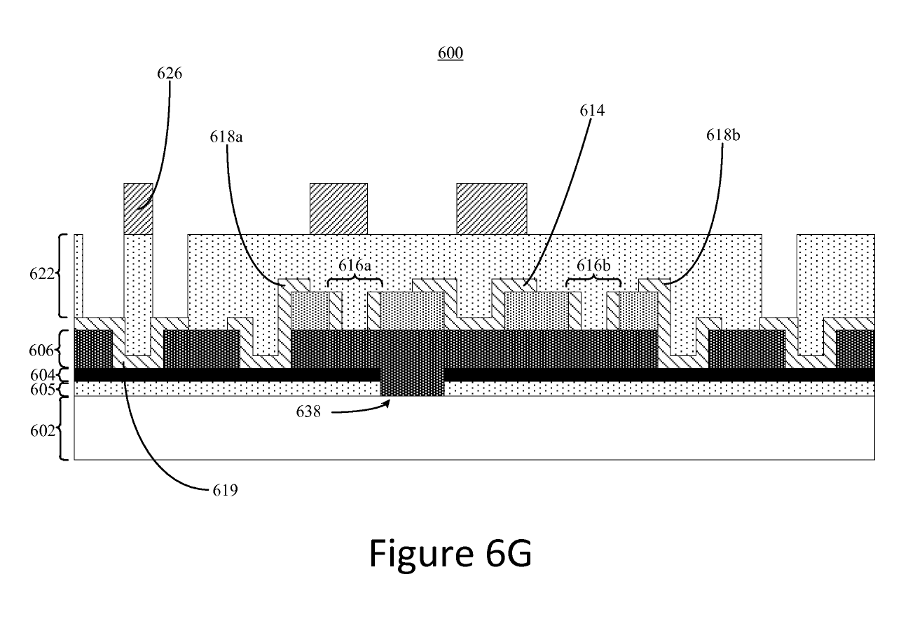

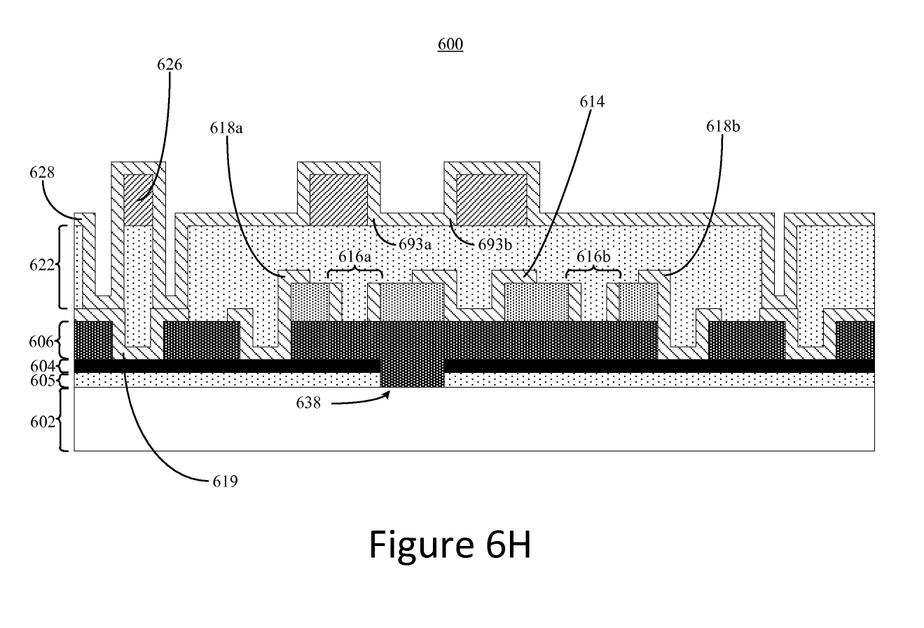

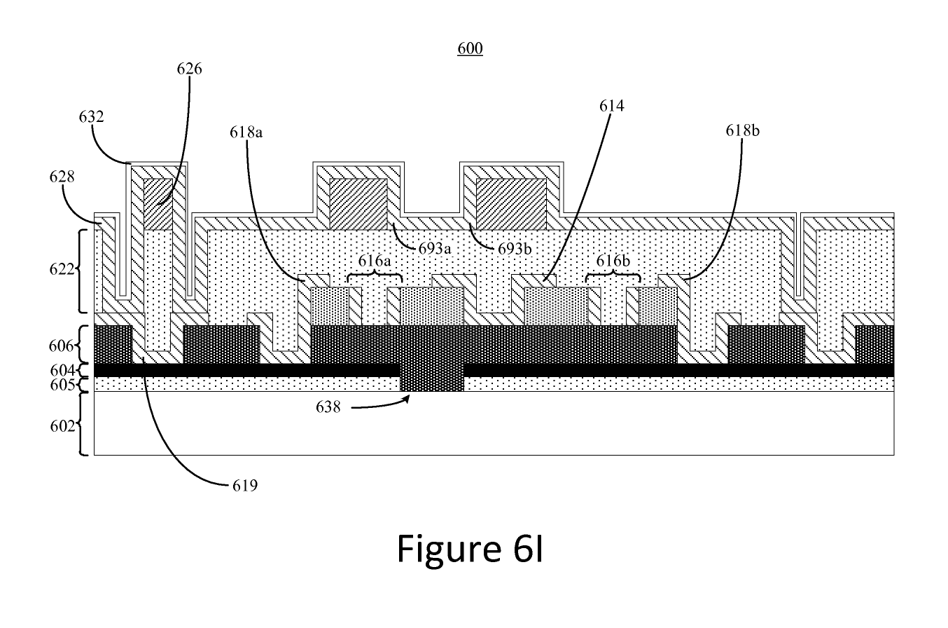

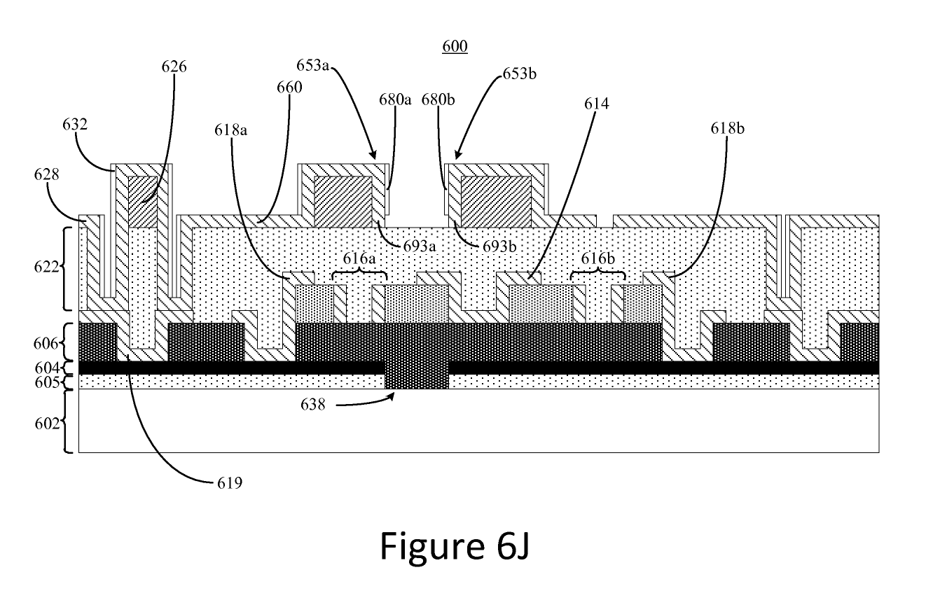

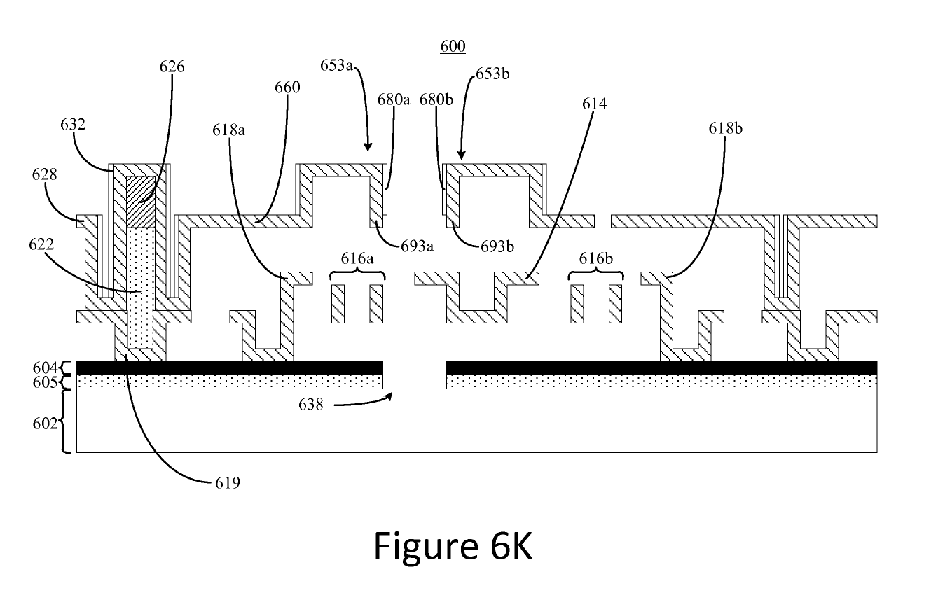

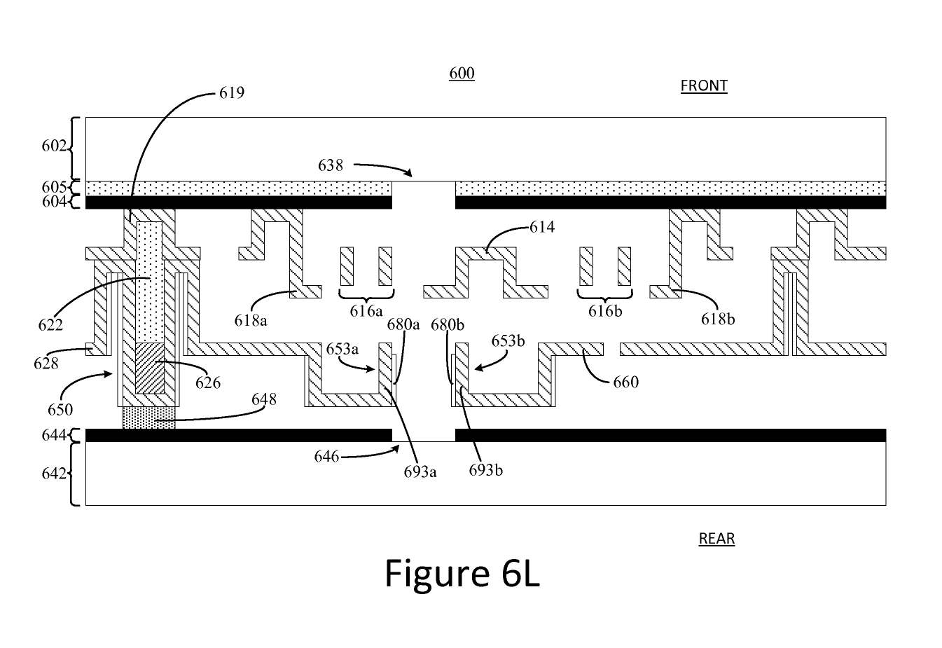

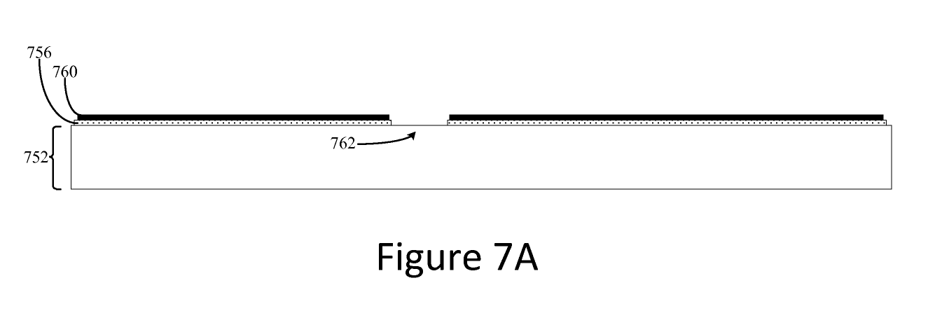

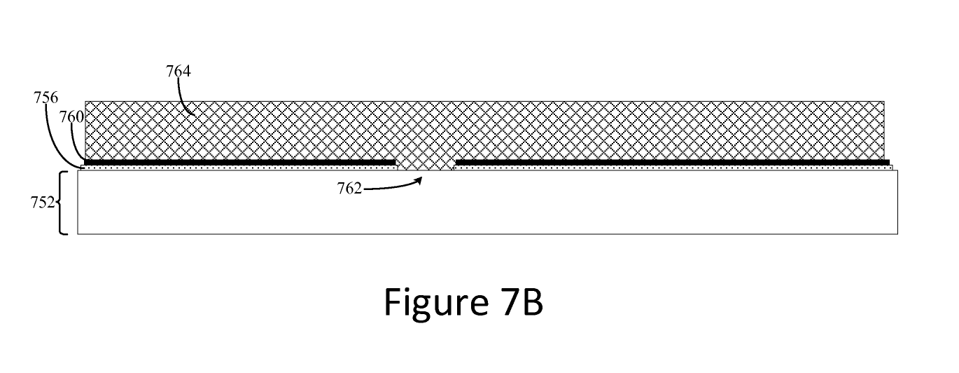

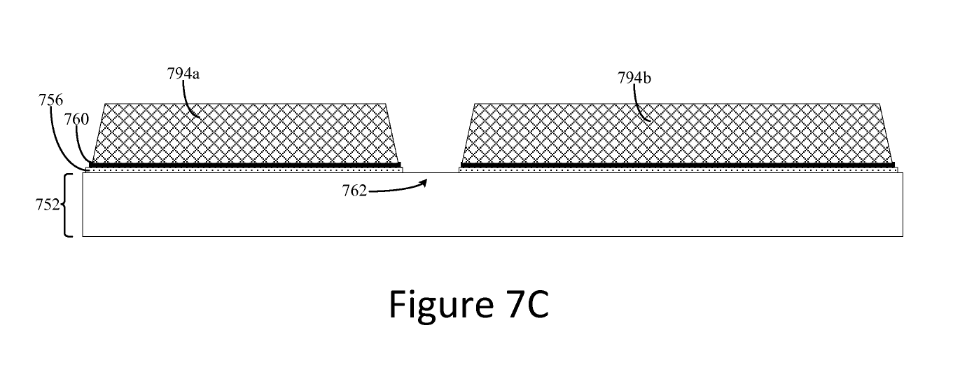

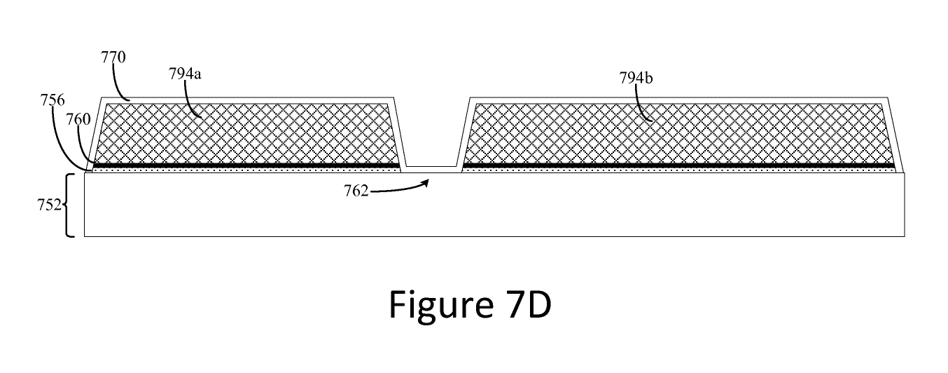

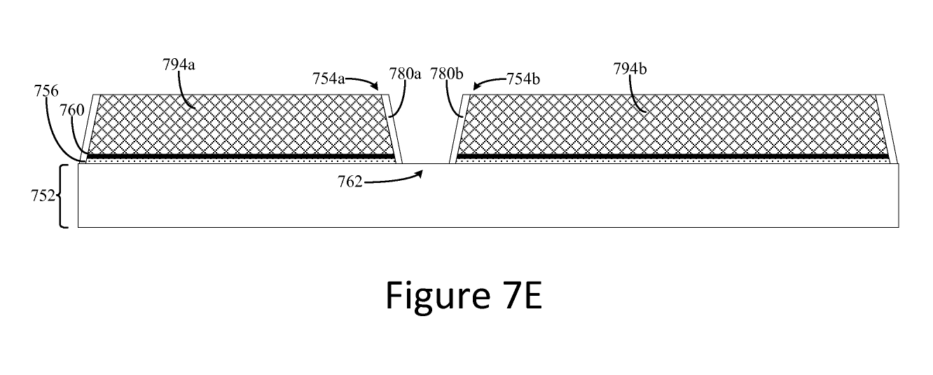

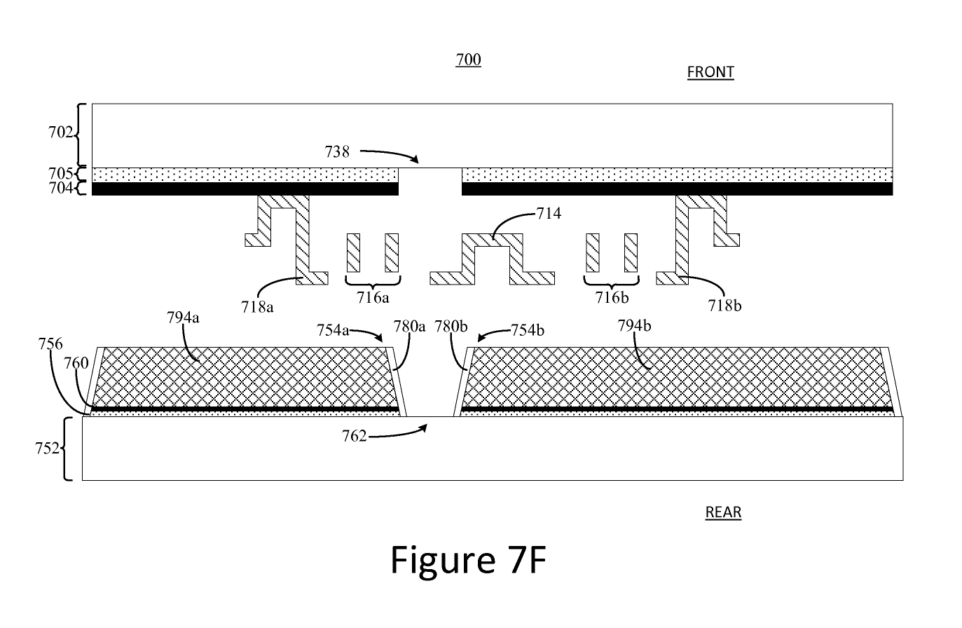

FIG. 5 shows a flow chart of an example process 500 for manufacturing a display device with collimating structures. In brief overview, the process 500 includes forming a light blocking layer defining a plurality of apertures over a first substrate (stage 510), forming structural projections including sidewalls over the light blocking layer (stage 515), coating the sidewalls of the structural projections with a reflective material (stage 520), and coupling the first substrate to a second substrate (stage 525). In some implementations, the structural projections can be formed on the same substrate on which a plurality of display elements are also formed, as described below in connection with FIGS. 6A-6L. In some other implementations, the structural projections can be formed on a substrate opposite the substrate on which a plurality of display elements are also formed, as described below in connection with FIGS. 7A-7F.

FIGS. 6A-6L show cross-sectional views of stages of construction of an example display device 600 according to the manufacturing process shown in FIG. 5. The display device 600 is similar to the display device 400a shown in FIG. 4A. The process 500 of FIG. 5 and the manufacturing stages of FIGS. 6A-6L are described together below. The process 500 includes forming a light blocking layer defining a plurality of apertures over a first substrate (stage 510). For example, as shown in FIG. 6A, a light blocking layer 604 can be deposited and patterned to form an aperture 638 over a substrate 602. A backplane 605 is positioned beneath the light blocking layer 604. The backplane 605 can include circuitry, such as pixel control circuits, for driving the display elements that will be formed over the substrate 602. While the backplane 605 is shown as a single element, it should be understood that the backplane 605 may include several layers of material deposited over the substrate 602. For example, layers of conductive material, semiconducting material, and dielectric material may be deposited and patterned to define circuitry forming the backplane 605.

A first layer of polymer material 606 can be deposited over the substrate. The first layer of polymer material 606 can be or can include polyimide, polyamide, fluoropolymer, benzocyclobutene, polyphenylquinoxylene, parylene, polynorbornene, polyvinyl acetate, polyvinyl ethylene, and phenolic or novolac resins, or any other materials suitable for use as a sacrificial material in thin-film MEMS processing. Depending on the material selected for use as the first layer of polymer material 606, the first layer of polymer material 606 can be patterned using a variety of photolithographic techniques and processes such as direct photo-patterning (for photosensitive sacrificial materials) or chemical or plasma etching through a mask including a photolithographically patterned resist. After the patterning, the remaining polymer material can be cured, for example by baking or exposure to ultraviolet radiation. The pattern defined in the polymer material 606 creates recesses which form portions of a mold for shutter assembly anchors and spacers to be included in the display device 600.

In some implementations, the process 500 can include depositing and patterning additional layers of polymer material to further define the components of the display device 600. As shown in FIG. 6A, a second layer of polymer material 608 can be deposited and patterned to form recesses over the first layer of polymer material 606. Some of the recesses in the second layer of polymer material 608 expose the recesses in the first layer of polymer material 606. Other recesses in the second layer of polymer material 608 serve as a mold for other portions of shutter assemblies formed in the process 500.

A first layer of structural material 610 can be deposited over the layers of polymer material 606 and 608 to coat the surfaces of the mold, as shown in FIG. 6B. In some implementations, the structural material 610 is deposited using a chemical vapor deposition (CVD) process or a plasma-enhanced CVD (PECVD) process. In some implementations, the structural material 610 can include one or more layers of amorphous silicon (a-Si), titanium (Ti), silicon nitride (Si₃N₄), aluminum (Al), copper (Cu), nickel (Ni), chromium (Cr), molybdenum (Mo), tantalum (Ta), niobium (Nb), neodymium (Nd), or alloys thereof. For example, in some implementations, the structural material 610 can include a layer of semiconductor material on which a layer of metal is deposited or vice versa.

The structural material 610 can be patterned, as shown in FIG. 6C. For example, a photoresist mask can be deposited and patterned over the structural material 610. The pattern developed into the photoresist mask can be selected such that, after a subsequent etch stage, the remaining structural material 610 forms a light blocking portion of a shutter 614, along with actuators 616a and 616b and anchors 618a and 618b, similar to the shutter 206, actuators 202 and 204 and anchors 208, shown in FIGS. 2A and 2B. The remaining structural material 610 also forms the first portion 619 of a spacer. The etch of the structural material 610 can be an anisotropic etch, an isotropic etch, or a combination of anisotropic and isotropic etches. In some implementations, the shutter 614, the actuators 616a and 616b, the anchors 618a and 618b, and the first portion 619 of the spacer can be formed using multiple patterning and etching steps.

A third layer of polymer material 622 can be deposited over the substrate 602, as shown in FIG. 6D. The third layer of polymer material 622 can be or can any of the materials suitable for use as a sacrificial material in thin-film MEMS processing described above. Depending on the material selected for use as the third layer of polymer material 622, the third layer of polymer material 622 can be patterned using a variety of photolithographic techniques and processes such as direct photo-patterning (for photosensitive sacrificial materials) or chemical or plasma etching through a mask including a photolithographically patterned resist, as shown in FIG. 6E. After the patterning, the remaining polymer material can be cured, for example by baking or exposure to ultraviolet radiation. The pattern defined in the third layer of polymer material 622 creates recesses, the walls of which form portions of a mold for the spacer to be included in the display device 600.

The process 500 includes forming structural projections over the light blocking layer (stage 515). In some implementations, another polymer mold can be used to form the structural projections. For example, As shown in FIG. 6F, a fourth layer of polymer material 626 can be deposited and over the third layer of polymer material 622. The fourth layer of polymer material 626 can then be patterned to form recesses over the third layer of polymer material 622, as shown in FIG. 6G. The walls of the recesses in the fourth layer of polymer material 626 serve as a mold for portions of the spacer and the structural projections that will be formed in the process 500.

A second layer of structural material 628 can be deposited over the third and fourth layers of polymer material 622 and 626 to coat the surfaces of the mold, as shown in FIG. 6H. In some implementations, the second layer of structural material 628 is deposited using a chemical vapor deposition (CVD) process or a plasma-enhanced CVD (PECVD) process. In some implementations, the structural material 628 can include one or more layers of any of the materials discussed above in connection with the first layer of structural material 610. For example, in some implementations, the second layer of structural material 628 can include a layer of semiconductor material on which a layer of metal is deposited or vice versa. The layer of structural material can define the structural projections 693a and 693b (generally referred to as structural projections 693) and the spacer.

The process 500 includes coating the sidewalls of the structural projections 693 with a reflective material (stage 520). As shown in FIG. 6I, a reflective material 632 can be deposited over the second layer of structural material 628. In some implementations, the reflective material 632 can be or can include a reflective metal. For example, the reflective material 632 can be or can include Al, Ti, or silver (Ag). In some implementations, the reflective material 632 can be a dielectric mirror or a dielectrically enhanced mirror.

As shown in FIG. 6J, the reflective material 632 and the second layer of structural material 628 can be patterned. The pattern can be selected to further define the structural projections 693. The remaining reflective material 632 coats the sides of the underlying second layer of structural material 628, including the surfaces of the sidewalls of the structural projections 693, to form reflective sidewalls 680a and 680b (generally referred to as reflective sidewalls 680). Together, the structural projections 693 and the reflective sidewalls 680 form collimating structures 653a and 653b (generally referred to as collimating structures 653). In some implementations, the second layer of structural material 628 can be patterned to be absent in the area aligned with the aperture 638, where the smaller gap between the shutter 614 and the reflective sidewalls 680 benefits optical performance (such as less clipping when the shutter is open and less light leakage when the shutter is closed), but present in certain other areas such as above the actuators 616, where the larger gap allows for increased reliability, lower power consumption, and faster actuation of the shutter 614. As shown in FIG. 6K, the polymer materials 606, 608, 622, and 626 can then be removed. In some implementations, the polymer materials 606, 608, 622, and 626 not encapsulated within the structural material 610 and 628 can be removed using standard MEMS release methodologies, including, for example, exposing the mold to an oxygen plasma, wet chemical etching, or vapor phase etching. However, the polymer material 622 and 626 encapsulated by the structural material 610 and 628 within the first portion 619 of the spacer is shielded from the release process, and therefore remains encapsulated.

The process 500 includes coupling the first substrate to a second substrate (stage 525). The results of this stage are shown in FIG. 6L. In some implementations, the first substrate 602 can be coupled to a second substrate 642 by an edge seal (not shown). The edge seal can be formed from, or can include, an epoxy. A spacer 650 includes the first portion 619 of the spacer 650 and a second portion 648 positioned over the second substrate 642. In some implementations, additional spacer portions similar to the second portion 648 on the second substrate 642 also can be aligned with the collimating structures 653. In such implementations, these spacer portions can be used to further prevent light from being lost in the gap between the second substrate 642 and the collimating structures 653. In some implementations, such additional spacer portions can include, or be coated with, reflective materials. A light blocking layer 644 is positioned over the second substrate 642 and defines an aperture 646 aligned with the aperture 638 in the light blocking layer 604 deposited over the first substrate 602. As shown in FIG. 6L, the reflective sidewalls 680 of the collimating structures 653 are positioned around the edges of the rear aperture 646 in the light blocking layer 644. As a result, the reflective sidewalls 680 can reflect light passing at a high angle through the rear aperture 646 back towards the opposite edge of the front aperture 638. This can help to improve the angular distribution of light and reduce clipping loss in the display device 600, as described above.

The cross-sectional views of FIGS. 6A-6L show a display device formed in a “MEMS-down” configuration, in which the display elements are formed over the front substrate of the display device 600. However, in some implementations, a similar technique could be applied to a display manufactured in a “MEMS-up” configuration, in which the display elements are formed over the rear substrate. Thus, the collimating structures 653 could be fabricated using a similar process in a MEMS-down configuration to position the collimating structures 653 adjacent to the edges of a front aperture rather than a rear aperture.

FIGS. 7A-7F show cross-sectional views of stages of construction of another example display device 700 that can be manufactured according to the manufacturing process shown in FIG. 5. The display device 700 is similar to the display device 400b shown in FIG. 4B. In contrast to the manufacturing stages shown in FIGS. 6A-6L, the manufacturing stages of FIGS. 7A-7F show a display device in which structural projections are formed on a substrate opposite the substrate on which the display elements are formed. The process 500 of FIG. 5 and the manufacturing stages of FIGS. 7A-7F are described together below. The process 500 includes forming a light blocking layer defining a plurality of apertures over a first substrate (stage 510). As shown in FIG. 7A, a reflective light blocking layer 756 can be deposited and patterned to form an aperture 762 over a substrate 752. In some implementations, additional light blocking layers also can be deposited and patterned over the substrate 752. For example, FIG. 7A also shows a light absorbing layer 760 positioned over the reflective layer 756. The light absorbing layer 760 also is patterned to further define the aperture 762. In some implementations, other layers also can be deposited over the substrate 752. For example, one or more backplane layers can be positioned beneath the light absorbing layer 760 and the reflective layer 756. A backplane layer can include, for example, layers of conductive material, semiconducting material, and dielectric material deposited and patterned to define circuitry forming the backplane.

The process 500 also includes forming structural projections including sidewalls over the light blocking layer (stage 515). As shown in FIG. 7B, a layer of material 764 is deposited over the substrate. In some implementations, the layer of material 764 can be a planarizing layer of spin-on-glass or dark spin-on-glass. In some implementations, the layer of material 764 can be a polymer material suitable for use in MEMS processing. In some implementations, the layer of material 764 can be a photoresist. The thickness of the layer of material 764 can be selected based on a desired height of the sidewalls of the structural projections that will include the layer of material 764. For example, in some implementations the layer of material 764 can be deposited to a thickness between about 1 micron and about 5 microns.

As shown in FIG. 7C, the layer of material 764 can be patterned to define the structural projections 794a and 794b (generally referred to as structural projections 794). Depending on the material selected for use as the layer of material 764, the layer of material 764 can be patterned using a variety of photolithographic techniques and processes such as direct photo-patterning (for photosensitive sacrificial materials) or chemical or plasma etching through a mask formed from a photolithographically patterned resist. For example, a mask including a gap corresponding to the aperture 762 can be deposited over the layer of material 764. The mask can be exposed to ultraviolet light, and the exposed portions of the material 764 can be removed. In some implementations, the process used to pattern the layer of material 764 can be selected to achieve a desired slope for the sidewalls of the structural projections 794 around the aperture 762. For example, an anisotropic dry etching process can be used to achieve angled sidewalls by removing more of the material 764 at greater distances away from the substrate 752. In some other implementations, the material 764 can be patterned to define vertical sidewalls around the aperture 762. In some other implementations, the material 764 can be additionally patterned in places other than near aperture 762. After the patterning, the remaining material 764 can be cured, for example by baking or exposure to ultraviolet radiation. In some implementations, the sidewalls of the structural projections 794 may be substantially vertical prior to the baking process. Baking the structural projections 794 can cause the sidewalls of the structural projections 794 to become sloped at an angle, as shown in FIG. 7C.

The process 500 includes coating the sidewalls of the structural projections 794 with a reflective material (stage 520). As shown in FIG. 7D, a reflective material 770 can be deposited over the structural projections 794. In some implementations, the reflective material 770 can be or can include a reflective metal, such as Al, Ti and Ag. In some implementations, the reflective material 770 can be a dielectric mirror or a dielectrically enhanced mirror. As shown in FIG. 7E, the reflective material 770 can be patterned. The pattern can be selected such that the remaining reflective material 770 coats the sidewalls of the structural projections 794, resulting in the reflective sidewalls 780a and 780b (generally referred to as reflective sidewalls 780) shown in FIG. 7E. Together, the structural projections 794 and the reflective sidewalls 780 form collimating structures 754a and 754b (generally referred to as collimating structures 754). In some implementations, the process 500 also can include depositing and patterning a light absorbing layer over the front-facing surfaces of the structural projections 794. This can help to prevent light leakage in the display device 700, by reducing the amount of light that reflects off of internal surfaces within the display device 700.

The process 500 includes coupling the first substrate to a second substrate (stage 525). The results of this stage are shown in FIG. 7F. In some implementations, the first substrate 752 can be coupled to a second substrate 702 by an edge seal (not shown). The edge seal can include, or can be formed from, an epoxy. A backplane layer 705 and a light blocking layer 704 are formed over the second substrate 702. An aperture 738 is defined through the light blocking layer 704 and aligned with the aperture 762 in the reflective layer 756 and the light absorbing layer 760 deposited over the first substrate 752. A display element has been fabricated over the second substrate 702. The display element includes a shutter 714, actuators 716a and 716b, and anchors 718a and 718b. As shown in FIG. 7F, the reflective sidewalls 780 of the collimating structures 754a and 754b are positioned around the edges of the rear aperture 762. As a result, the reflective sidewalls 780 of the collimating structures 754 can reflect light passing at a high angle through the rear aperture 762 back towards the opposite edge of the front aperture 738. This can help to improve the angular distribution of light and reduce clipping loss in the display device 700, as described above. In some implementations, the material 764 of FIG. 7B can be patterned to be absent in certain other areas besides that of rear aperture 762, such as in areas that would align with actuators 716 shown in FIG. 7F. In some implementations, this creates a larger cell gap in those areas and allows for increased reliability, lower power consumption, and faster actuation of the shutter 714.

The cross-sectional views of FIGS. 7A-7F show a display device formed in a MEMS-down configuration, in which the display elements are formed over the front substrate of the display device 700. However, in some implementations, a similar technique could be applied to a display manufactured in a MEMS-up configuration, in which the display elements are formed over the rear substrate. Thus, the display element could instead be formed using a MEMS-up process, such that after the first substrate 752 is coupled to the second substrate 702, the collimating structures 754 are adjacent to the edges of a front aperture rather than a rear aperture.

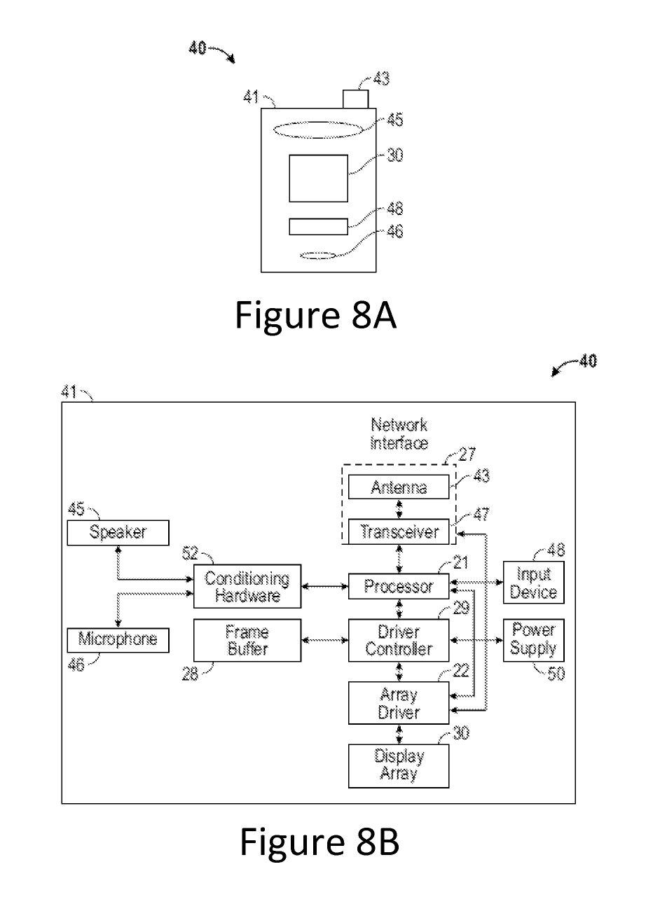

FIGS. 8A and 8B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 8B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 8A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display apparatus comprising:
a first substrate;
a second substrate substantially parallel to the first substrate;
an array of light modulators positioned between the first substrate and the second substrate;
a first light blocking layer positioned on the first substrate and defining a first plurality of apertures;
a second light blocking layer positioned on the second substrate and defining a second plurality of apertures, each of the second plurality of apertures aligned with a respective aperture in the first plurality of apertures; and
a first plurality of reflective sidewalls each adjacent to at least one edge of a respective aperture of the first plurality of apertures and between the first and second substrates.

2. The display apparatus of claim 1, wherein each of the first plurality of sidewalls is oriented at an angle between about 45 degrees and about 90 degrees with respect to a surface of the first substrate.

3. The display apparatus of claim 1, wherein each of the first plurality of apertures has a length to width ratio in the range of about 4:1 to about 6:1.

4. The display apparatus of claim 1, wherein the first plurality of sidewalls includes sidewalls positioned adjacent to a longer edge of each aperture of the first plurality of apertures.

5. The display apparatus of claim 1, wherein each sidewall surrounds its respective aperture.

6. The display apparatus of claim 1, further comprising a plurality of structural projections positioned over the first light blocking layer, wherein each sidewall of the first plurality of reflective sidewalls is positioned on a surface of a respective structural projection.

7. The display apparatus of claim 6, wherein each structural projection has a height in the range of about 1.5 microns to about 5 microns.

8. The display apparatus of claim 6, wherein the structural projections include a light blocking material.

9. The display apparatus of claim 6, further comprising a light blocking material positioned on a surface of each of the structural projections farthest from the first substrate.

10. The display apparatus of claim 1, wherein each reflective sidewall comprises at least one of aluminum, titanium, and silver.

11. The display apparatus of claim 1, wherein each reflective sidewall comprises at least one of a dielectric mirror and a dielectrically enhanced mirror.

12. The display apparatus of claim 1, further comprising an aperture layer positioned between the first light blocking layer and the second light blocking layer, the aperture layer defining a third plurality of apertures each aligned with a respective aperture in the first plurality of apertures.

13. The display apparatus of claim 12, wherein the aperture layer comprises the reflective sidewalls.

14. The display apparatus of claim 1, wherein each light modulator is coupled to and suspended over one of the first substrate and the second substrate.

15. The display apparatus of claim 1, further comprising a second plurality of reflective sidewalls each positioned adjacent to at least one edge of a respective aperture of the second plurality of apertures.

16. The display apparatus of claim 1, further comprising:
a processor capable of communicating with the display apparatus, the processor being capable of processing image data; and
a memory device capable of communicating with the processor.

17. The display apparatus of claim 16, further comprising:
a driver circuit capable of sending at least one signal to the display apparatus; and
a controller capable of sending at least a portion of the image data to the driver circuit.

18. The display apparatus of claim 16, further comprising:
an image source module capable of sending the image data to the processor, wherein the image source module includes at least one of a receiver, transceiver, and transmitter; and
an input device capable of receiving input data and communicating the input data to the processor.

19. A method of manufacturing a display apparatus, comprising:
forming a light blocking layer over a first substrate, the light blocking layer defining a first plurality of apertures each corresponding to a respective display element; and
forming a plurality of structural projections over the light blocking layer such that each structural projection includes at least one sidewall positioned adjacent to at least one edge of a respective aperture in the light blocking layer, wherein the sidewalls of the plurality of structural projections include a reflective material.

20. The method of claim 19, further comprising forming an array of light modulators over the first substrate, each light modulator corresponding to a respective display element.

21. The method of claim 19, further comprising forming an array of light modulators over the second substrate, each light modulator corresponding to a respective display element.

22. The method of claim 19, wherein each structural projection has a height in the range of about 1.5 microns to about 5 microns.

23. The method of claim 19, wherein each sidewall is oriented at an angle between about 50 degrees and about 90 degrees with respect to a surface of the first substrate.

24. The method of claim 19, further comprising coating the sidewalls of the plurality of structural projections with a reflective material by:
depositing at least one of aluminum (Al), titanium (Ti), and silver (Ag) over the sidewalls of the structural projections; and
removing the layer of reflective material from a top surface of each structural projection.

25. The method of claim 19, further comprising coating the sidewalls of the plurality of structural projections with a reflective material by:
depositing at least one of a dielectric mirror layer and a dielectrically enhanced mirror layer over the sidewalls of the structural projections; and
removing the layer of reflective material from a top surface of each structural projection.

26. The method of claim 19, further comprising depositing a light absorbing material on a top surface of each structural projection.

27. The method of claim 19, further comprising:
forming a second light blocking layer over the second substrate, the second light blocking layer defining a second plurality of apertures each corresponding to a respective display element;
forming a second plurality of structural projections over the second light blocking layer such that each structural projection includes at least one sidewall positioned adjacent to at least one edge of a respective aperture in the light blocking layer; and
coating the sidewalls of the second plurality of structural projections with a reflective material.

28. An apparatus comprising:
a first substrate;
a second substrate substantially parallel to the first substrate;
an array of light modulating means between the first substrate and the second substrate;
a first light blocking means on the first substrate and defining a first plurality of apertures; and
a second light blocking means on the second substrate and defining a second plurality of apertures, each of the second plurality of apertures aligned with a respective aperture in the first plurality of apertures; and
a plurality of light reflecting means each adjacent to at least one edge of a respective aperture of the first plurality of apertures and between the first and second substrates.

29. The apparatus of claim 28, wherein each of the plurality of light reflecting means is oriented at an angle between about 50 degrees and about 90 degrees with respect to a surface of the first substrate.

30. The display apparatus of claim 28, wherein the plurality of light reflecting means includes light reflecting means positioned adjacent to a longer edge of each aperture of the first plurality of apertures.
